(19) United States
(12) Patent Application Publication
(10) Pub. No.: US 2019/0174736 A1
(43) Pub. Date: Jun. 13, 2019

(54) CARTRIDGE FOR INSECT TRAPPING DEVICE AND METHODS THEREOF

(71) Applicant: The Procter & Gamble Company, Cincinnati, OH (US)

(72) Inventors: Christopher Lawrence Smith, Liberty Township, OH (US); Danilo ROSSI, Trento (IT); Andrea PEDROTTI, Cavedine (IT)

(21) Appl. No.: 16/245,187

(22) Filed: Jan. 10, 2019

Related U.S. Application Data
(63) Continuation of application No. PCT/US2017/032438, filed on May 12, 2017.
Application No. PCT/US2017/032438 is a continuation of application No. PCT/US2016/041812, filed on Jul. 11, 2016.
Application No. PCT/US2016/041812 is a continuation of application No. PCT/US2016/041811, filed on Jul. 11, 2016.

(51) Int. Cl. A01M 1/14

(52) U.S. Cl. CPC A01M 1/145; A01M 1/023

(57) ABSTRACT

An insect trapping cartridge is provided. The cartridge has a proximal end receivable into a base of an insect trapping device. The proximal end has a substantially planar, longitudinally extending tab that activates a switch in the base. The tab of the cartridge is laterally offset from a centerline of the cartridge.

### TECHNICAL FIELD

The present disclosure generally relates to insect trapping devices, and more specifically to cartridges for portable insect trapping devices.

### BACKGROUND

Historically, a variety of pest control devices have been employed to trap insects and other pests. With recent outbreaks of various diseases, infections, and other health risks that are spread by insects, the need for pest control devices has only increased. Such pest control devices typically employ an attraction mechanism for luring pests to the pest control device. Example attraction mechanisms include baits such as food, light, heat, pheromones, or other odorous materials found attractive by the pest. Some pest control devices have historically included an immobilization mechanism to prevent the pest from exiting the pest control device. One type of immobilization mechanism used is a substrate such as a board, paper or other medium having a surface coated with an adhesive. Pests attracted to the pest control device or incidentally coming into contact with the adhesive become trapped by adhesion.

For some consumers, it is desirable to have a pest control device that is capable of simultaneously attracting and capturing a wide variety of flying insects, including mosquitoes, flies, moths, and so forth. However, mosquitoes can be particularly dangerous. Certain species of mosquitoes are known carriers of a number of diseases, including malaria, dengue fever, yellow fever, the west nile virus and the zika virus. Of these diseases, malaria has been described by some as the “most prevalent and most pernicious disease of humans”. White, N., Antimalarial Drug Resistance, The Journal of Clinical Investigation, Vol. 113, no. 8 (2004). As of 2010, the World Health Organization estimated that 219 million cases of malaria and 660,000 deaths occurred. Daniel, J., Drug Resistant Malaria—A Generation of Progress in Jeopardy, Center for Strategic & International Studies (2013). Tragically, malaria is the third leading cause of death for children under the age of 5, claiming more 50 lives every hour. Id. Some mosquito species believed to be carriers of human disease, such as Aedes Aegypti, Aedes Albopictus, Aedes Canadensis, Anopheles Gambiae, Anopheles Fenustus, Culex Annulirotris, Culex Annulus and Culex Pipiens.

Heat is a known attractant for mosquitoes. See, e.g., Maekawa et al., The role of proboscis of the malaria vector mosquito Anopheles stephensi in host-seeking behavior, Parasites and Vectors, 4:10 (2011). Greppi et al. observed that “mosquitoes were strongly attracted to a target when heated above ambient, but only up to ˜50° C. When it got hotter, this attraction declined strongly.” Greppi et al., Some like it hot, but not too hot, eLife 4:e12838 (2015). See, also, Corfas et al., The cation channel TRPA1 tunes mosquito thermotaxis to host temperatures, eLife 4:e11750 (2015). Mosquitoes and other insects can also be attracted to light sources. See, e.g., Burkett et al., Laboratory evaluation of colored light as an attractant for female Aedes agypti, Aedes albopictus, Anopheles quadrimaculatus and Culex nigripalpus, The Florida Entomologist, Vol. 88, No. 4 (2005).

Insect trapping devices that combine an adhesive for trapping insects together with light and heat are known, some examples being described in PCT patent publication WO 2015/164,849. Some such devices utilize a cartridge that is selectable attached to a base that houses electrical componentry. In some instances, the cartridge may contain an attractant, such as a liquid or gel. However, there are opportunities for improvement. Indeed, it would be advantageous to provide an insect trapping device having electrical components that are mounted in a manner that reduces the risk of inadvertent contact with liquids and gels in a cartridge in the event of a leak. It would further be advantageous to provide a cartridge that energizes such electrical components by closing a switch when the cartridge is mounted to a base and ensures for proper orientation and alignment when mounting it to the base. It would further be advantageous to provide an insect trapping device having a base with a switch that is arranged in a compact manner that minimizes the risk of a user inserting a finger or foreign object into the base and contacting the switch or other electrical components therein, some of which may involve high voltages. It would still be further be advantageous to provide a cartridge having a structure for closing a switch in a base, wherein the cartridge structure is arranged in manner that accommodates the aforementioned desirable features of a base. While numerous opportunities for improvement are described above, it will be appreciated that the disclosure hereafter is not limited to devices that provide any or all such improvements.

### SUMMARY

The present disclosure fulfills one or more of the needs described above by, in one embodiment, an insect trapping cartridge for use with a base. The insect trapping cartridge comprises a proximal end receivable into a base during use. The proximal end comprises a substantially planar, longitudinally extending tab having a first side edge and a second side edge. The insect trapping cartridge also comprises a distal end opposite the proximal end, an elongate enclosure for receiving an insect, and an adhesive surface for trapping the insect. The insect trapping cartridge has a longitudinal centerline dividing the insect trapping cartridge into lateral sides. The first side edge and the second side edge of the tab are each laterally offset from the longitudinal centerline of the insect trapping cartridge and positioned on the same lateral side of the insect trapping cartridge.

In another embodiment, an insect trapping cartridge for use with a base comprises a proximal end receivable into a base during use. The proximal end comprises a longitudinally extending tab having a substantially planar area. The insect trapping cartridge further comprises a distal end opposite the proximal end, an elongate enclosure for receiving an insect, and an adhesive surface for trapping the insect. The insect trapping cartridge has a longitudinal centerline and the substantially planar area of the tab does not overlap the longitudinal centerline of the insect trapping cartridge.

### BRIEF DESCRIPTION OF THE DRAWINGS

The above-mentioned and other features and advantages of the present disclosure, and the manner of attaining them, will become more apparent and the disclosure itself will be better understood by reference to the following description of nonlimiting embodiments of the disclosure taken in conjunction with the accompanying drawings, wherein:

FIG. 1 depicts an example insect trapping device;

FIG. 2 is an exploded view of the insect trapping device depicted in FIG. 1;

FIG. 3A is an exploded view of the cartridge of FIG. 1;

FIG. 3B is a cross-sectional view of the cartridge of FIG. 3A taken along line 3B-3B subsequent to the insertion of the insert;

FIG. 4 depicts the cartridge of FIG. 3A being coupled to a base;

FIG. 5A depicts an isometric view of the base of FIG. 1;

FIG. 5B depicts a partial cutaway view of the base of FIG. 5A;

FIGS. 6A-6B are isometric views of an insert having a light source;

FIGS. 7A-7B are isometric views of an insert having a light source and a reservoir;

FIG. 8 depicts an exploded view of an example frameless insert;

FIGS. 9A-9B are isometric views of an another example cartridge;

FIG. 10 is an exploded view of the cartridge shown in FIGS. 9A-9B;

FIG. 11 depicts an example insect trapping device using the cartridge of FIGS. 9A-9B;

FIG. 12 is a lateral cross-sectional view of the cartridge and the base of FIG. 11 taken through the geometric center of the shroud subsequent to the coupling of the cartridge to the base and;

FIGS. 13A-13B are isometric exploded views of an example cartridge having a light source;

FIG. 14 depicts an example cartridge having a shell that can be loaded with an insert and then coupled to a base;

FIG. 15 depicts an exploded isometric view of an insect trapping device;

FIG. 16 is a side cross-sectional view of the insect trapping device of FIG. 15 taken along its vertical axis;

FIG. 17 shows an exploded front view of a shell with an associated base with the front housing of the shell not shown for illustration purposes;

FIG. 18 shows a rear view of the shell of FIG. 17;

FIG. 19 depicts an example insect trapping device showing a shell subsequent to the drilling of holes at approximately 1 cm intervals;

FIG. 20 depicts the insect trapping device of FIG. 19 showing an adhesive portion subsequent to the drilling of holes at approximately 1 cm intervals and prior to the re-attachment of the shell;

FIG. 21 is a perspective view of an insect trapping device having a heated, vented housing with a circuit board therein containing resistive heating diodes and two light emitting diodes (LEDs);

FIG. 22 is a front plan view of the circuit board described with respect to FIG. 21;

FIG. 23 depicts a heat map for the front face of the adhesive portion generated from the device of FIGS. 21 and 22;

FIG. 24 depicts another heat map for the front face of the adhesive portion generated from the device of FIGS. 21 and 22;

FIG. 25 depicts a heat map for the front face of an adhesive portion generated from a device similar to that shown in FIGS. 4 and 5;

FIGS. 26A-26B depict an attachment of an example cartridge to an example base 1002;

FIG. 27 is an isometric view of the base shown in FIGS. 26A-26B;

FIG. 28 depicts a partial cutaway view of a chamber defined by the base with a cartridge installed;

FIG. 29A is a cross-sectional view of the base and the cartridge of FIG. 28 taken along line 29A-29A;

FIG. 29B is a cross-sectional view of the base of FIG. 29A with the cartridge removed and the switch in the open position;

FIG. 30 depicts an example tab configuration;

FIG. 31 depicts an another example tab configuration;

FIG. 32 depicts yet another example tab configuration; and

FIG. 33 depicts an example asymmetric tab configuration.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DETAILED DESCRIPTION

The present disclosure provides for insect trapping devices, methods of making insect trapping devices, and methods of using insect trapping devices. Various nonlimiting embodiments of the present disclosure will now be described to provide an overall understanding of the principles of the function, design and use of the insect trapping devices disclosed herein. One or more examples of these nonlimiting embodiments are illustrated in the accompanying drawings. Those of ordinary skill in the art will understand that the methods described herein and illustrated in the accompanying drawings are nonlimiting example embodiments and that the scope of the various nonlimiting embodiments of the present disclosure are defined solely by the claims. The features illustrated or described in connection with one nonlimiting embodiment can be combined with the features of other nonlimiting embodiments. Such modifications and variations are intended to be included within the scope of the present disclosure.

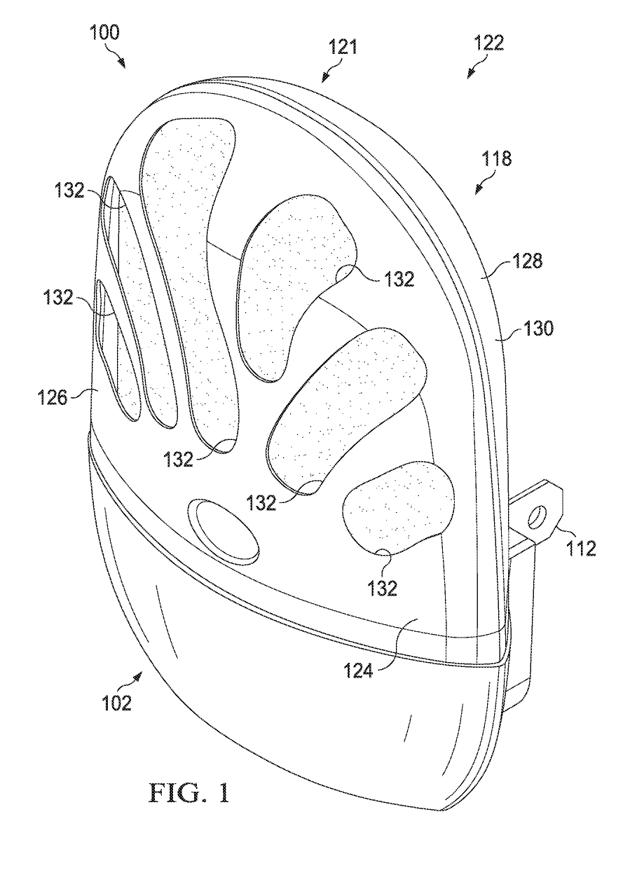

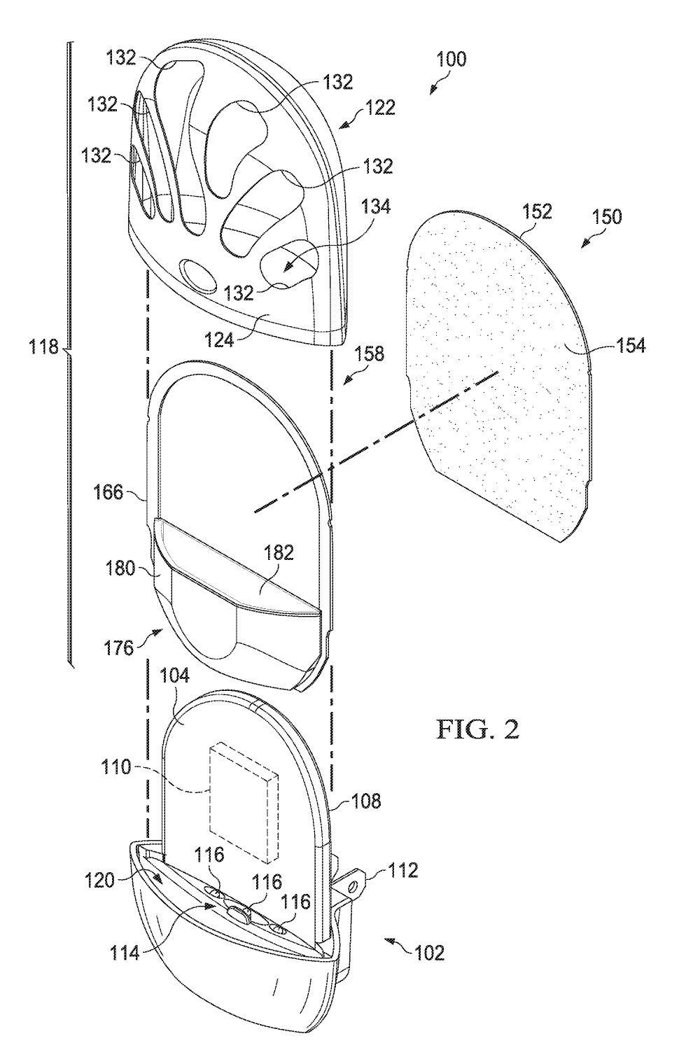

Referring now to FIGS. 1-2, an example insect trapping device 100 in accordance with one non-limiting embodiment is depicted. FIG. 2 is an exploded view of the insect trapping device 100 depicted in FIG. 1. The insect trapping device 100 has a base 102 and a cartridge 118 that can be selectively coupled to the base 102 by a user. The cartridge 118 includes an insert 150 and a shell 122 that is configured to receive the insert 150. As described in more detail below, the insert 150 can include an adhesive portion 152 that immobilizes insects that contact a front face 154 of the adhesive portion 152. The base 102 can include prongs 112 such that the insect trapping device 100 can be plugged into a suitable power source, such as a wall socket. In other configurations the insect trapping device 100 can draw power from an onboard battery or other type of power source (i.e., solar). The insect trapping device 100 can utilize a variety of attractants to draw insects into the device, such as heat, light, chemical composition attractants, and so forth, some of which may require a power source to operate. As such, the power source may be used to energize various onboard components, such as an electric heating element 110, a light source 114, and/or other components which may serve to attract insects to the insect trapping device 100. With regard to the electric heating element 110, a wide variety of heating elements may be utilized. Example electric heating elements include, but are not limited to, metal heating elements, ceramic heating elements, polymeric heating elements, composite heating elements, and/or combinations thereof.

The shell 122 may have front housing 124 that has a front surface 126 and a rear housing 128 that has a rear surface 130. The front housing 124 and the rear housing 128 can be separate pieces that are coupled together to form the shell 122, or the front housing 124 and the rear housing 128 can be a unitary piece which integrally forms the shell 122. The front housing 124 and the rear housing 128 substantially can enclose the adhesive portion 152 of the insert 150 once the insert is seated within the shell 122. Alternatively, in some configurations, an adhesive portion is provided to a user predisposed within the shell, such as illustrated by cartridges 518 and 618, described below.

The front surface 126 may define one or more openings 132 for receiving a flying or crawling insect such that they can come in contact with the front face 154 of the adhesive portion 152 of the insert 150. While FIGS. 1-2 depict one example arrangement of openings 132, it is to be appreciated that the size, arrangement, and number of the one or more openings 132 can vary.

The front housing 124 may be convex and spaced apart from the rear housing 128 at the bottom of the shell 122 such that they collectively define a bottom opening 134 (FIG. 2). The bottom of the shell 122 or insert 150 is determined when the shell 122 or insert 150 is oriented as it would be during use by a consumer to attract and capture the insects. The opposing sides of the bottom opening 134 may be tapered, grooved, or otherwise configured to aid in proper alignment of the insert 150 as it is slid into the shell 122 by a user. A top portion 121 of the shell 122 may be substantially or wholly closed (as shown by way of a non-limiting example in FIG. 1).

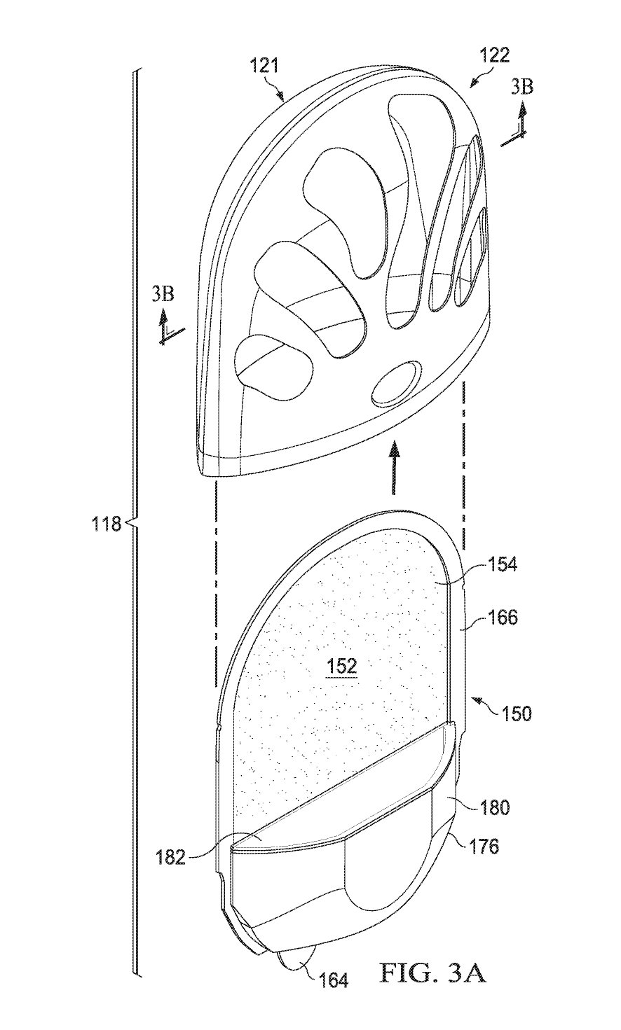

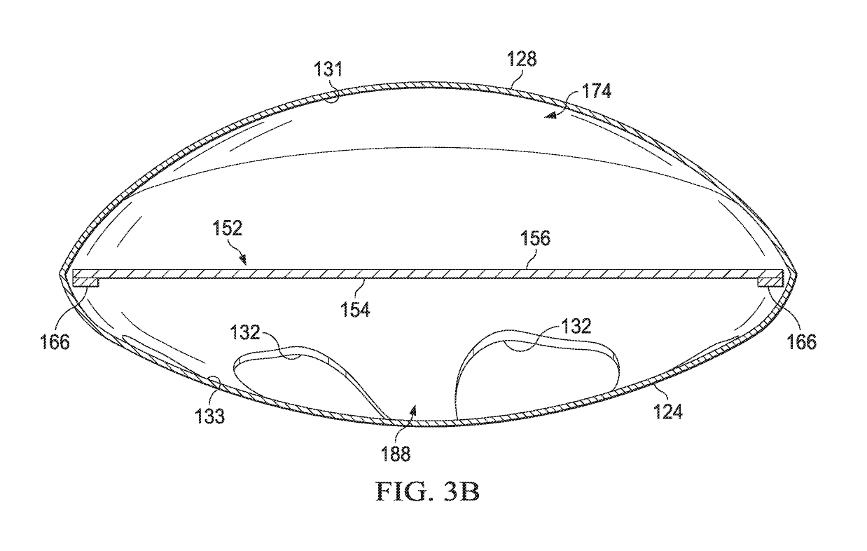

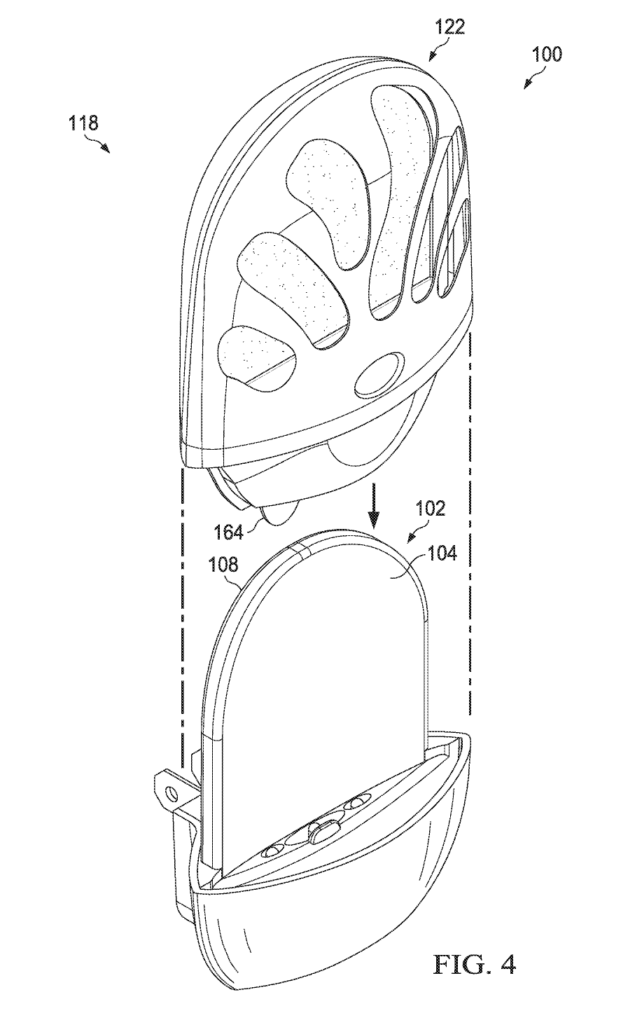

FIG. 3A depicts the insert 150 being inserted into the shell 122 and FIG. 3B is a cross-sectional view of the cartridge of FIG. 3A taken along line 3B-3B subsequent to the insertion of the insert 150. The insert 150 can comprise a frame 166 to which an adhesive portion 152 is attached or otherwise formed therewith. Once inserted into the shell 122, the adhesive portion 152 divides the shell 122 into a front cavity 188 and a rear cavity 174. The rear cavity 174 is defined by the rear face 156 of the adhesive portion 152 and the inner surface 131 of the rear housing 128 while the front cavity 188 is defined by the front face 154 of the adhesive portion 152 and the inner surface 133 of the front housing. Once the insert 150 is positioned within the shell 122, the cartridge 118 can be engaged with the base 102. FIG. 4 depicts the cartridge 118 of FIG. 3A being coupled to the base 102. The rear cavity 174 can be devoid of openings, with the exception of the bottom opening which is effectively sealed to the ambient environment when the cartridge 118 is coupled to the base 102. This arrangement of the rear cavity 174 can limit heat loss from the rear cavity 174 due to convection to the ambient environment when the insect trapping device 100 is in use. By comparison, the front cavity 188 includes one or more openings 132 to allow insects to enter the front cavity 188 thereby exposing that cavity to the ambient environment.

Referring now to FIGS. 1-4, the adhesive portion 152 immobilizes insects that enter the insect trapping device 100 through one of the openings 132 of the shell 122 and contact the adhesive. In some embodiments, the adhesive portion 152 comprises an adhesive (or an adhesive composition comprising an adhesive), wherein the adhesive or adhesive composition is coated on or otherwise applied to or incorporated in or on a substrate. The adhesive may be a pressure sensitive adhesive. In some embodiments, the adhesive is an acrylic polymer, butyl rubber, natural rubber, nitrile, silicone, styrene block copolymer, styrene-ethylene/propylene, styrene-isoprene-styrene, and/or vinyl ether adhesive or mixture thereof, for example. The substrate may be provided in a wide variety of forms, such as a film, a woven or a non-woven (including papers). In some embodiments, the substrate is in the form of a film comprising one or more polymers, such as polycarbonate, polyethylene terephthalate (PET) or polypropylene. The substrate may comprise one or more layers. Generally, the thickness of the adhesive portion 152 may be in the range of about 0.01 mm to about 5 mm. In some embodiments, the adhesive thickness may be in the range of about 0.05 mm to about 1.0 mm. The surface area of the adhesive portion 152 can be between about 25 cm² and about 150 cm². The adhesive portion 152 can comprise a transparent or translucent adhesive or adhesive composition coated onto a transparent or translucent substrate (such as a film, for example). A releasable liner can be applied to the adhesive portion 152 that is to cover the adhesive portion 152 prior to use. A user can peel away the releasable liner to expose the front face 154 of the adhesive portion 152 immediately prior to inserting the insert 150 into the shell 122, for instance.

While the insert 150 is shown to include a frame 166 completely surrounding the adhesive portion 152, this disclosure is not so limited. For instance, the frame 166 may only extend partially around the adhesive portion 152. In one example configuration, the frame 166 may extend along a first vertical side of the adhesive portion 152, across the top of the adhesive portion 152, and down the second vertical side of the adhesive portion 152. In such configuration, the bottom edge of the adhesive portion 152 is unframed. In other configurations, the insert 150 can be frameless, with the adhesive portion 152 applied at least to a central portion of a substrate, with the substrate providing sufficient structural rigidity. Further, the adhesive portion 152 can be planar, as shown, or have other suitable configurations, such as curved, for instance. As shown in FIG. 2, FIG. 3A, and FIG. 3B, the outer perimeter of the frame 166 may be shaped similarly to the shell 122.

In some configurations, the insert 150 has a reservoir 176 for storing an insect attracting composition. The insect attracting composition can be provided in a wide variety of forms, including gases, liquids, solids and combinations thereof. In some embodiments, the insect attracting composition may be provided in the form of a solid composition comprising one or more agents attractive to an insect. Solid compositions also include semi-solid compositions such as gels, which comprise one or more liquids and one or more gelling agents. The gelling agents may facilitate the formation of a cross-linked network within the insect attracting composition. The reservoir 176 may also serve to catch fallen insects, such as the insects that were originally immobilized by the adhesive portion 152 but are no longer sufficiently retained by the adhesive portion 152 after drying and becoming brittle. The reservoir 176 may be defined by a front wall 180 (FIG. 2) and a rear wall 182, with the front wall 180 defining at least part of an opening of the reservoir 176. The front wall 180 may be integrally formed with the frame 166. The reservoir 176 may have a depth of about 1 mm and about 30 mm, a width from about 10 mm to about 100 mm, and a height from about 1 mm to about 50 mm. The reservoir 176 can have a volume between about 1 cm³ and 60 cm³. The reservoir 176 can be positioned such that once the insert 150 is engaged with the shell 122 and the shell 122 is engaged with the base 102, the insect attracting composition may evaporate or disperse through the openings 132. Reservoirs in accordance with the present disclosure, such as reservoir 176, may be made as one piece, including its rear wall 182, which is then attached to the frame 166. Alternatively, reservoirs, including its rear wall, may be integrally formed with the frame from the same material, such as by an injection molding or thermoforming process. The adhesive portion 152 may terminate adjacent the reservoir opening or may downwardly extend past the reservoir opening and across the rear wall 182 of the reservoir 176. Since the insect attracting composition within the reservoir 176 may evaporate during use, it is advantageous that the reservoir 176 is coupled to the adhesive portion 152 so that both components can be replaceable simultaneously. Furthermore, due to the placement of the reservoir 176 relative to the adhesive portion 152, the reservoir 176 can be received into the base so as to not block surface area of the adhesive portion 152. This arrangement maximizes the surface area of the adhesive portion 152 for trapping insects.

In other configurations, the insert 150 may not include a reservoir 176. In yet other configurations, the insert 150 does not include a reservoir 176 and the adhesive portions 152 are positioned on both the front and rear faces of the insert 150. In such configurations, once the front face 154 of the adhesive portion 152 has immobilized a sufficient number of insects, the user may remove the insert 150 from the shell 122, rotate the insert 150, and re-insert the insert 150 into the shell 122. In this position, the rear face of the insert 150 is positioned proximate to the openings 132 and can be used to immobilize insects entering the shell.

As shown in FIG. 3A, the insert 150 may be selectively inserted into to the shell 122 by a user to prepare the cartridge 118 for attachment to the base 102. In some configurations, the insert 150 may be mechanically engaged with the shell 122 when the insert 150 is fully seated with the shell 122, such as through interlocking features or a friction-fit, for instance. Example configurations for inserts and shells are provided in co-filed patent application Ser. No. ______, entitled INSECT TRAPPING DEVICE AND METHODS THEREOF and filed on ______, the disclosure of which is hereby incorporated by reference. The cartridge 118 also comprises a downwardly depending tab 164. The downwardly depending tab 164 can be positioned on the insert 150 or on the shell 122. A switch (not shown) is positioned on the base 102 that receives the downwardly depending tab 164 when the cartridge 118 engages the base 102. The switch in the base 102 can function to operate one or more of the insect attractants (i.e., the electric heating element 110, the light source 114, etc.), so that such insect attractants can only be energized when the cartridge 118 is engaged to the base 102. As such, when the cartridge 118 is removed from the base 102, the switch is deactivated and power is removed from the insect attractants.

The downwardly depending tab 164 can be positioned such that a vertical centerline of downwardly depending tab 164 is offset from a vertical centerline of the insert 150. Offsetting of the downwardly depending tab 164 may serve to aid in properly aligning the cartridge 118 with the base 102. More specifically, the cartridge 118 may only be fully seated into the base 102 when the cartridge 118 is facing the proper direction so that the downwardly depending tab 164 is received into the switch. Furthermore, the downwardly depending tab 164 can help to insure the insert 150 is properly arranged in the shell 122. The downwardly depending tab 164 can also function as a convenient grip point for the user during insertion or removal of the insert 150. The downwardly depending tab 164 can have any suitable configuration or shape. In some configurations, the downwardly depending tab 164 has a width at its vertical midpoint that is less than 75% the width of the bottom edge of the insert 150. In some configurations, the downwardly depending tab 164 has a width at its vertical midpoint that is less than 50% the width of the bottom edge of the insert 150. In some configurations, the downwardly depending tab 164 has a width at its vertical midpoint that is less than 25% the width of the bottom edge of the insert 150. In some configurations, the downwardly depending tab 164 has a width at its vertical midpoint that is less than 10% the width of the bottom edge of the insert 150. In some configurations, the downwardly depending tab 164 overlaps the vertical centerline of the insert 150 while being asymmetric about the vertical centerline of the insert 150.

To couple the cartridge 118 to the base 102 to prepare the insect trapping device 100 for use, the cartridge 118 is lowered over a shroud 108 (FIG. 4), such that the shroud 108 is received into the rear cavity 174 (FIG. 3B) of the shell 122 through the bottom opening 134 (FIG. 2) and positioned between a rear face of the adhesive portion 152 and an inner surface of the rear housing 128. The shroud 108 is an upstanding portion extending upward from the base 201 that envelops the electric heating element 110. The relative positioning and alignment of the cartridge 118 to the base 102 during coupling can be assisted by the shroud 108, as the shroud 108 can serve to properly guide the cartridge 118 onto the base 102. Further, the receiving of the shroud 108 into the shell 122 during coupling also helps assure proper alignment of the downwardly depending tab 164 with a switch positioned in the base 102. A portion of the base 102 may be received into the shell 122 to mechanically engage the cartridge 118 to the base 102. Such engagement may utilize a friction-fit connection, or other suitable type of connection, such as utilizing a clip, latch, magnet, or detent, for example, to maintain the coupling between the shell 122 and the base 102 until the user wishes to decouple the cartridge 118 and the base 102. Once the cartridge 118 is affixed to the base 102, the insect trapping device 100 can then be operated to attract and immobilize insects.

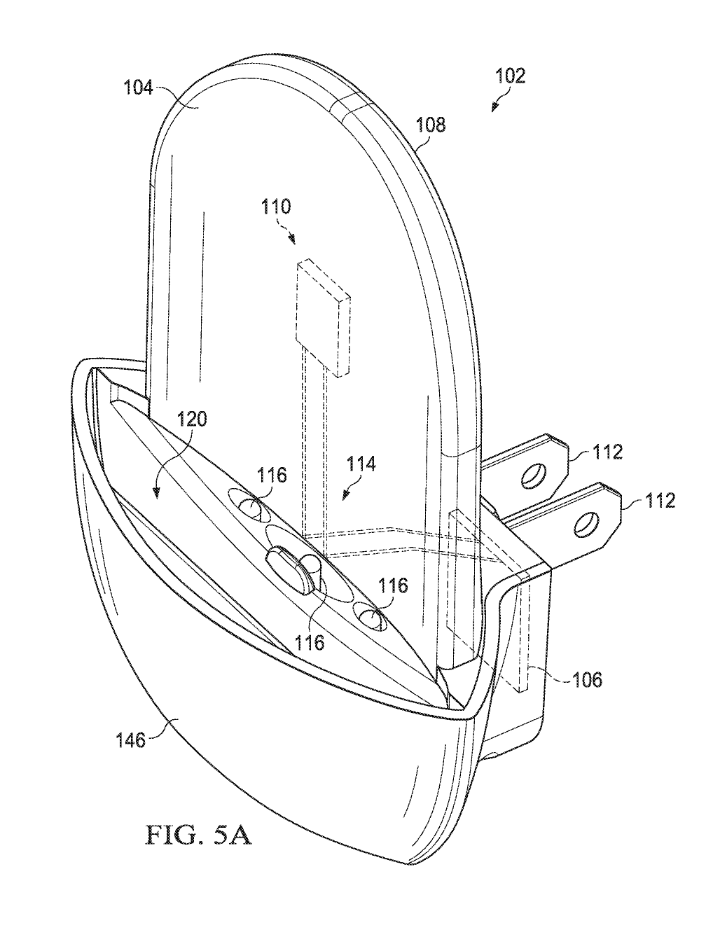

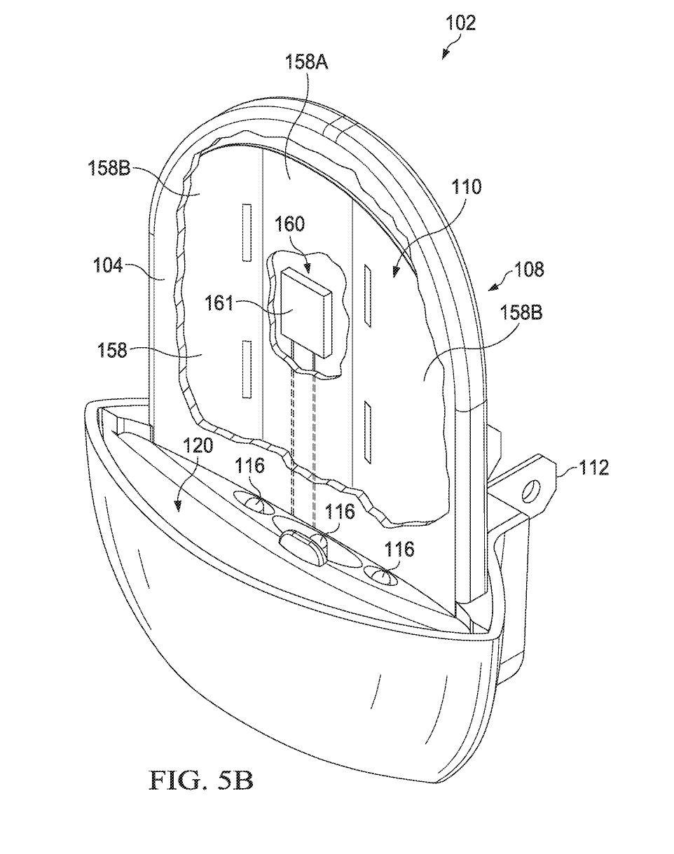

FIG. 5A depicts an isometric view of the base 102, shown with the cartridge 118 removed for clarity, and FIG. 5B depicts a partial cutaway view of the base 102 to illustrate the electric heating element 110 in more detail. Referring to FIGS. 1-5B, when the cartridge 118 is engaged to the base 102, the shroud 108 extends through the bottom opening 134 and into the rear cavity 174 of the shell 122 and is positioned between the rear housing 128 and the insert 150. In the illustrated configuration, the electric heating element 110 is positioned within the shroud 108. The shroud 108 protects the electric heating element 110 and assists with the dissipating the heat generated by the electric heating element 110 during operation. As used herein, electric heating element 110 refers to the devices that convert electricity to heat for the purposes of heating. As such, wiring, control circuitry, connectors, mounts, and the like that may be associated with an electric heating element 110 are not components of the electric heating element 110. The electric heating element 110 may be, for example, a positive temperature coefficient (PTC) heater having one or more heatable surfaces, a resistance-based heater, or any other type of element that converts electrical energy into thermal energy. Further, the temperature of the electric heating element 110 may be controlled through self-regulation or utilize various temperature control circuitry, such as thermostats and the like. As is to be appreciated, this disclosure is not to be limited to any particular type of electric heating element 110 or control circuitry. However, the use of a PTC thermistor as the electric heating element 110 may offer a less complex and less costly means for heating the shroud 108 than provided by other heating techniques. Electric heating elements requiring thermostats, for instance, may require the positioning of the additional components and feedback circuitry within the base 102, which could result in more complex manufacturing processes.

When energized by a suitable power source (batteries, wall socket, etc.), the electric heating element 110 heats the shroud 108. The shroud 108 then radiates heat first to the rear face of proximate adhesive portion 152 of the insert 150 which is disposed adjacent to a front surface 104 of the shroud 108. As the rear face of the adhesive portion 152 is heated, then the opposing front face 154 of the adhesive portion 152 is heated. Accordingly, the heat path of the insect trapping device 100 is from the electric heating element 110, to the shroud 108, to the rear surface of the adhesive portion 152 (via convection heating and/or radiant heating), which in turn warms the front face 154 of the adhesive portion 152. Warming the adhesive portion 152 may aid in attracting certain types of insects to the insect trapping device 100. For instance, the heated adhesive portion 152 may mimic the thermal signature of a biological surface (i.e., skin) and, therefore, attract insects drawn to skin, such as mosquitos, fleas, ticks, and so forth. Such insects will be drawn to the heated adhesive portion 152 and come into contact with the front face 154 of the adhesive portion 152, thereby becoming trapped.

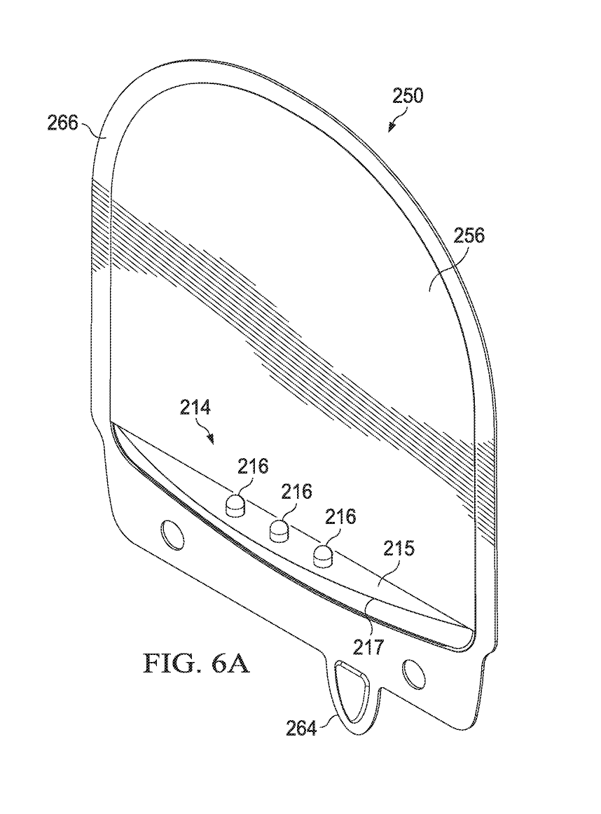

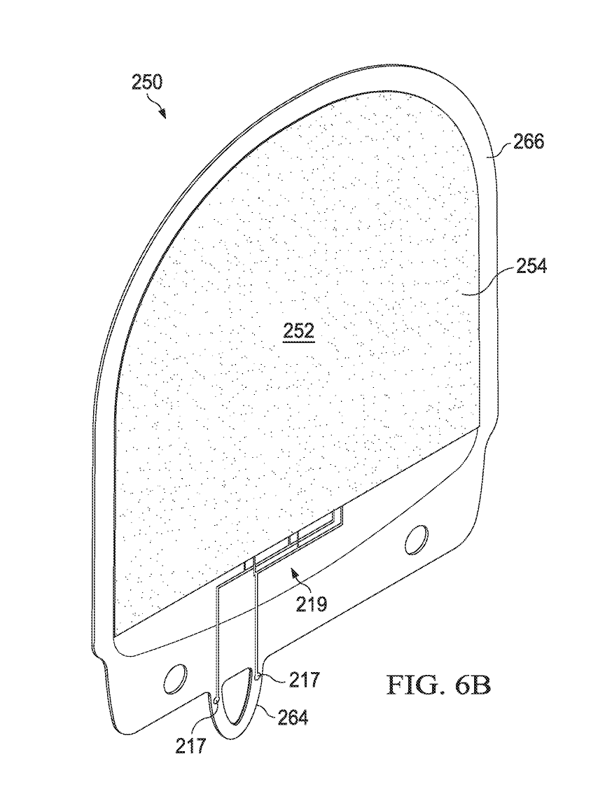

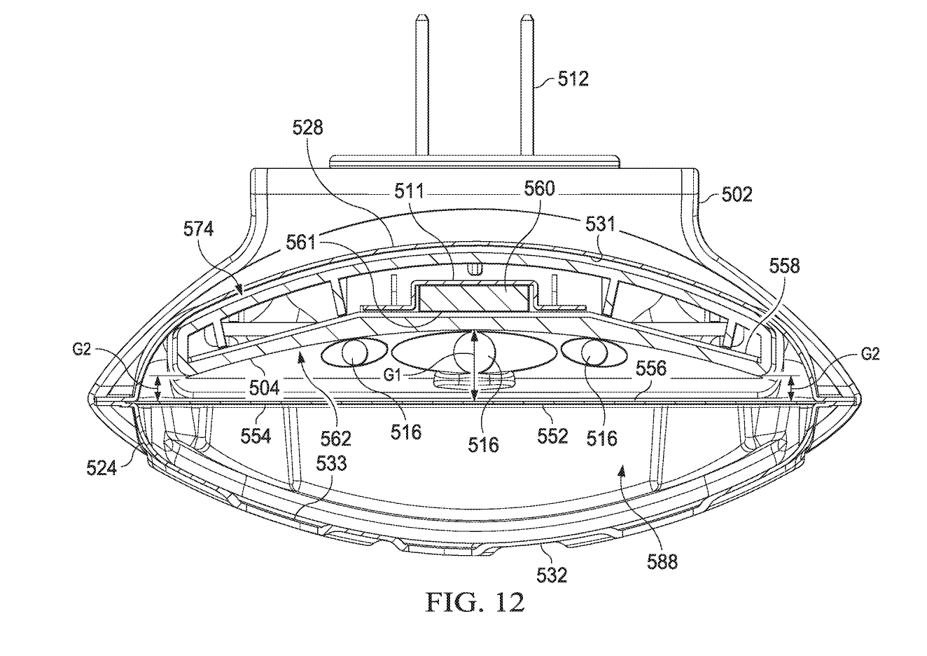

In the illustrated configuration, the light source 114 serves as another insect attractant and is positioned within the base 102. The wavelength and type of light source 114 that are utilized can be selected to attract insects that are drawn to certain types of light. The light source 114 is shown as light emitting diodes (LEDs) 116, which are a form of solid state lighting. In one embodiment, the light source 114 comprises three LEDs 116. The LEDs 116 may use any suitable attachment technology, such as through-hole technology. In some configurations one or more of the LEDs 116 utilize surface-mount technology (SMT) such that the LEDs 116 are a surface-mount device (SMD). Each of the LEDs 116 may have a diameter between about 0.5 mm and about 10 mm. Further, each of the LEDs may have a surface area of 0.5 mm² and about 100 mm². Some examples of LEDs include semi-conductor light emitting diodes, polymer light emitting diodes, organic light emitting diodes, etc. Other light sources that may be used include, but are not limited to, incandescent or filament based lights, fluorescent lights, halogen lights, xenon lights or other light sources known in the art. The lights may or may not have a filter to adjust the wavelength of their output. Further, as used herein, the light source 114 is the light generating component or element of the lighting technology utilized as the insect attractant. In this regard, the light source 114 may be any of a diode, a filament, an energized gas, and so forth. The light source 114 does not include wiring, connectors, bases, lenses, or elements that may be associated with the light generating component or element. The light source 114 is positioned external to the upstanding heat shroud 108. The light source 114 may be in front of, below, beside, or mounted on a surface of the shroud 108. This positioning may allow the light to be more effectively deflected by the front surface 104 of the shroud 108 toward the adhesive portion 152. It also may provide for more even radiant heating by the front surface 104 of the shroud 108. Examples of such an external placement are illustrated as LEDs 116 in light source 114 in FIG. 2, and LEDs 216 on the insert 250 in FIG. 6A, and LEDs 516 in FIG. 12. The light source 114 is positioned such that when the cartridge 118 is engaged to the base 102, the light source 114 is positioned between the shroud 108 and the insert 150. As such, when the light source 114 is energized, it illuminates rear face 156 of the adhesive portion 152 directly and indirectly by way of light reflecting off of the shroud 108. This configuration further enables an advantageous unobstructed light path between the LEDs 116 and the adhesive portion 152, and enables both light and heat to be provided as insect attractants without interference from one another. In some embodiments, the light source 114 is disposed at or near the base of the shroud 108 so as not to interfere with either the heat radiating from the shroud 108 or the reflection of light from the shroud 108 toward the rear face 156 of the adhesive portion 152. The illustrated configuration can also provide an effective forward transmission of the light from the light source 114. More specifically, the relative positioning of the LEDs 116 between the adhesive portion 152 and the shroud 108, while in close proximity to the shroud 108, increases the amount of forward deflection of the light through the adhesive portion 152. This configuration also provides an air gap between the shroud 108 and the adhesive portion 152 to help alleviate hot spots on the adhesive portion 152 that otherwise might be present when using a single point heater. The use of a single point heating element 110, such as shown in FIG. 5A, while simpler and less expensive may need to run hotter than a multi-point heating element and/or results in the center portion of the shroud being hotter than the edges of the shroud 108 due to the radiation/dissipation of the heat. The air mass created inside the rear cavity 174 of the shell 122, which in some embodiments envelops the shroud 108 about its front and rear surfaces, may further enhance the thermal stability and evenness of the heated surface of the adhesive portion 152. In this configuration, the light path is from the light source 114 to the rear face of the adhesive portion 152, either directly and/or reflected off the shroud 108. The light then travels through the rear face of the adhesive portion 152 and out the front face 156 of the adhesive portion 152. Insects drawn to the illuminated and heated adhesive portion 152 will become trapped by its front face 156, which is disposed within the front cavity 188 and opposite openings 132.

The shroud 108 can have a front surface 104 that faces the rear surface of the adhesive portion 152 of the cartridge 118. The front surface 104 can be concave such that a cavity is formed between the center portion of the shroud 108 and adhesive portion 152 when the cartridge 118 is engaged to the base 102. While the front surface 104 of the shroud 108 is illustrated as a smooth concave surface, this disclosure is not so limited. The front surface 104 can have any suitable configuration or combination of surfaces that form a concave shape in which the central portion of the front surface 104 is recessed relative to the side portions of front surface 104 thereby forming an inwardly directed bulge. Example configurations of the front surface 104 can include planar portions, beveled portions, curved portions, curvilinear portions, and so forth. Additionally, the front surface 104 can be continuous (as shown) or be discontinuous such that it has gaps or other types of separations. In some arrangements, the shroud 108 and its front surface 104 can be collectively formed by two or more shrouds that are positioned proximate to each other, either in direct contact or spaced apart. Such multi-shroud arrangements may not necessarily use a single point heating element, as each shroud may be heated separately. The light source 114 may be positioned on the base 102 within the cavity formed between the front surface 104 of the shroud 108 and the rear surface of the adhesive portion 152 when the cartridge 118 is engaged to the base 102. As such, in addition to lighting the adhesive portion 152, the light source 114 also illuminates the front surface 104 of the shroud 108. The relative positioning of the front surface 104 and the light source 114 can allow for the front surface 104 to serve as a reflector to reflect at least some of the light from the light source 114 onto the rear face 156 of the adhesive portion 152. As shown in FIG. 5A, for instance, the light source 114 is positioned in the base 102 at the bottom of the shroud 108. Further, the light source 114 is shown to be positioned below the front surface 104 of the shroud 108 as well as being positioned in front of the front surface 104. In accordance with various configurations, at least a portion of the front surface 104 may be roughened to aid in light diffusion, scattering, and/or reflection. In some configurations, the roughened portion of the front surface 104 has a surface roughness (Ra) from about SPI A-1 to about SPI D-3. Further, the roughened portion may have a surface area that is between about 70% to about 100% of the surface area of the front surface 104 of the shroud 108.

A circuit board 106 (FIG. 5A) can be positioned within the base 102 that includes the circuitry for operating the electric heating element 110 and the light source 114. The circuit board 106 may be vertically mounted within the base 102 so that it can be positioned behind the reservoir 176. With the circuit board 106 positioned behind the reservoir 176, the possibility of the insect attracting composition contacting the circuitry is minimized. As shown in FIGS. 5A-5B, the base 102 may also define a cavity 120 that is sized to receive at least a portion of the reservoir 176 when the shell 122 is coupled to the base 102.

When observing the insect trapping device 100 from the front side during operation (i.e., the side opposite of the prongs 112 in FIG. 12), the front face 154 of the adhesive portion 152 may be at least partially viewable through the openings 132. Since the light source 114 is positioned behind the adhesive portion 152, when the light source 114 is activated, the adhesive portion 152 is lit from its rear face. The shroud 108 that houses the electric heating element 110 is positioned behind both the adhesive portion 152 and the light source 114, and functions to heat the illuminated adhesive portion 152 to within a desired temperature range. Positioning the heating element 110 behind the adhesive portion 152 further provides an added advantage of hiding the relatively hot heating element 110 (which may be heated to greater than 50° C.) from the insects, particularly mosquitoes, entering the front enclosure through the openings 132 in the front housing 124 of the shell 122. As described in more detail below, due in part to the concave front surface 104 and the relative placement and configuration of the electric heating element 110 within the shroud 108, the entire surface area of the adhesive portion 152 can generally be evenly heated to aid in mimicking biological tissue while avoiding hot spots to increase the efficacy of the insect trapping device 100.

Referring now to FIG. 5B, a partial cutaway view of the base 102 depicts an example internal arrangement of the shroud 108. The electric heating element 110 comprises one or more PTC heating elements 160 that are in thermal contact with a metal plate 158. For the purposes of illustration, only one PTC heating element 160 is shown in FIG. 5B. An example PTC heating element is a switch type PTC thermistor, such as PTC Heating Element model number 15-6-.3 manufactured by ShenZhen Jinke Special Materials Co., Ltd. A planar front surface 161 of the PTC heating element 160, which is heated when the PCT heating element 160 is activated, is in contact with the metal plate 158. As such, the heat generated by the PTC heating element 160 is conductively spread across the surface area of the metal plate 158. The metal plate 158 can have a thickness from about 0.25 mm to about 1.5 mm and can be made from aluminum or other heat conducting material. The metal plate 158 can be sized such that it is generally the same size as the front surface 104. In some configurations, the metal plate 158 has a width that is greater than 5 cm and a surface area between about 23 cm² and about 148 cm². The width of the metal plate 158 is determined when the metal plate 158 is oriented as it would be during use by a consumer to attract and capture the insects.

Further, the metal plate 158 can be structured to generally follow the concaved geometry of the front surface 104. In the illustrated configuration, for instance, the metal plate 158 includes a planar central section 158A with planar wings 158B positioned on either side, with the wings 158B being angled relative to the central section 158A. In other configurations, the metal plate 158 is curved, or includes planar sections and curved sections. The PTC heating element 160 can be coupled to the metal plate 158 (such as to the central section 158A using any suitable technique, such as clips, adhesives, or the like.) In any event, the metal plate 158 assists with disbursing the heat generated by the PTC heating element 160 so that the shroud 108 can be heated.

Due to its proximity to the PTC heating element 160, the central area of the metal plate 158 will be hotter than the peripheral areas of the metal plate 158. As such, the portion of the front surface 104 of the shroud 108 proximate to the central area of the metal plate 158 may be hotter than portions of the front surface 104 of the shroud 108 that are proximate to the peripheral areas of the metal plate 158. Due to the concave arrangement of the front surface 104, however, the portions of the front surface 104 that are proximate to the peripheral areas of the metal plate 158 are positioned closer to the adhesive portion 152, and the portion of the front surface 104 that is proximate to the peripheral areas of the metal plate 158 is spaced further away from the adhesive portion 152. Such arrangement assists in the generally even heating of the entire surface area of the adhesive portion 152. Additional details regarding the relative spacing between the adhesive portion and the front surface of an example insect trapping device is described in more detail below with regard to FIG. 12.

During operation of the insect trapping device 100, once the electric heating element 110 is activated, the front surface 104 of the shroud 108 may reach a steady state average temperature in less than 1 hour. The steady state average temperature of the front surface 104 of the shroud 108 may be between about 40° C. and about 50° C. at an ambient temperature of about 23° C. Furthermore, the front surface 104 may have minimum and maximum steady state temperatures within +/−6, 8, 10, or 12° C. of the steady state average temperature at an ambient temperature of about 23° C. The absolute difference between the minimum and the maximum steady state temperatures of the front surface 104 can be about 10, 12, 14, 16, 18, 20, or 22° C. The adhesive portion 152 may have a steady state average temperature between about 32° C. and about 38° C. at an ambient temperature of about 23° C. At an ambient temperature of about 30° C. (which can be a proxy for hotter days in countries such as China or Brazil), the adhesive portion 152 may have a steady state average temperature between about 35° C. and about 40.5° C. The direct heat minimum and direct heat maximum steady state temperatures of the adhesive portion 152 may be within +/−1.5° C. of the steady state average temperature, or the direct heat minimum and direct heat maximum steady state temperatures of the adhesive portion 152 may be in the range of about +/−1.5° C. to about +/−3.5° C. of the steady state average temperature, or the direct heat minimum and direct heat maximum steady state temperatures of the adhesive portion 152 may be in the range of about +/−2.5° C. to about +/−3.5° C. of the steady state average temperature. The absolute difference between the direct heat minimum and the direct heat maximum can be less than about 2.5° C., 5° C., or 7.5° C. These are the minimum and maximum temperatures of that portion of the adhesive portion that is directly in front of the shroud. In some embodiments, greater than 50, 60%, 70%, 80% or 90% of the surface area of the adhesive portion is heated to temperatures that fall between the direct heat minimum temperature and the direct heat maximum temperature. The minimum steady state temperature and the maximum steady state temperature of the entire adhesive portion that is heated, whether or not directly in front of the shroud, may be within +/−5° C. of the steady state average temperature. The set point temperature (Ts) of the front surface 161 of the PTC heating element 160 may be between about 50° C. and about 70° C. Surface temperature test methods are provided below.

Providing the shroud 108 as a component of the base 102 is beneficial since it may be undesirable to discard the shroud 108 with the cartridge 118 of the device. Instead, components of the cartridge 118 (or the whole cartridge) can be replaced as-needed, with the shroud 108 remaining with the base 102. Moreover, by enclosing the shroud 108 with the cartridge 118 during operation of the insect trapping device 100, the cartridge 118 serves to chamber the shroud 108 to allow it to generally heat faster, more evenly, and with fewer effects from atmospheric perturbations and turbulence. If the shroud 108 is not chambered, it would need to operate at a higher temperature to heat the adhesive portion 152 to the desired temperature, thus making the insect trapping device 100 more susceptible to larger variations in surface temperatures of the adhesive portion 152. Further, since the shroud 108 is positioned within the rear cavity 174 and is not readily accessible by insects entering the front cavity 188 of the shell 122, hot spots and/or temperatures greater than 50° C. will not be readily visible to the insects such as mosquitoes. In addition, since surface area of the front surface 104 of the shroud 108 may be substantially similar to the surface area of front face 154 of the adhesive portion 152, it is easier to heat the rear face 156 of the adhesive portion 152 evenly to the desired temperature range. In some embodiments, the front surface 104 of the shroud 108 has a surface area that is 50%, 60%, 70%, 80%, 90% or more of the surface area of the rear face 156 of the adhesive portion 152.

Due to the relative placement of the adhesive portion 152 to the shroud 108, the configuration of the cartridge 118 also serves to beneficially minimize the amount of adhesive-free heated surface that insects might otherwise be attracted to, which would undesirably draw then away from the trapping adhesive surface of the device (i.e., adhesive portion 152). Finally, the shell 122 may prevent insects from detecting high temperature portions of the insect trapping device 100, which might otherwise repel the insects.

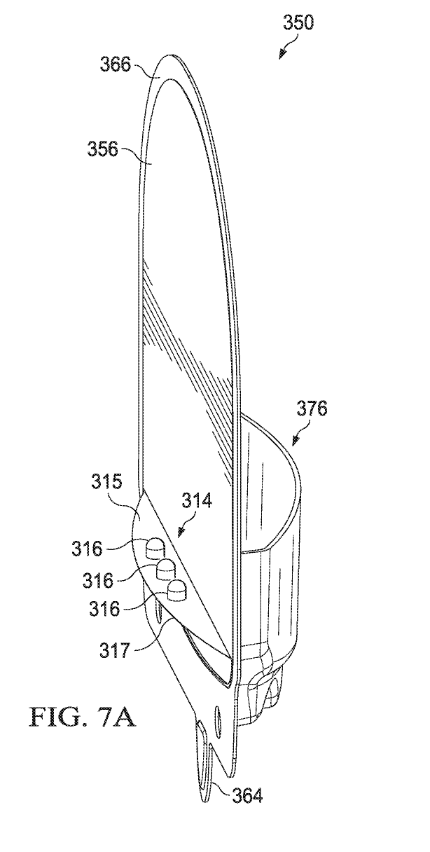

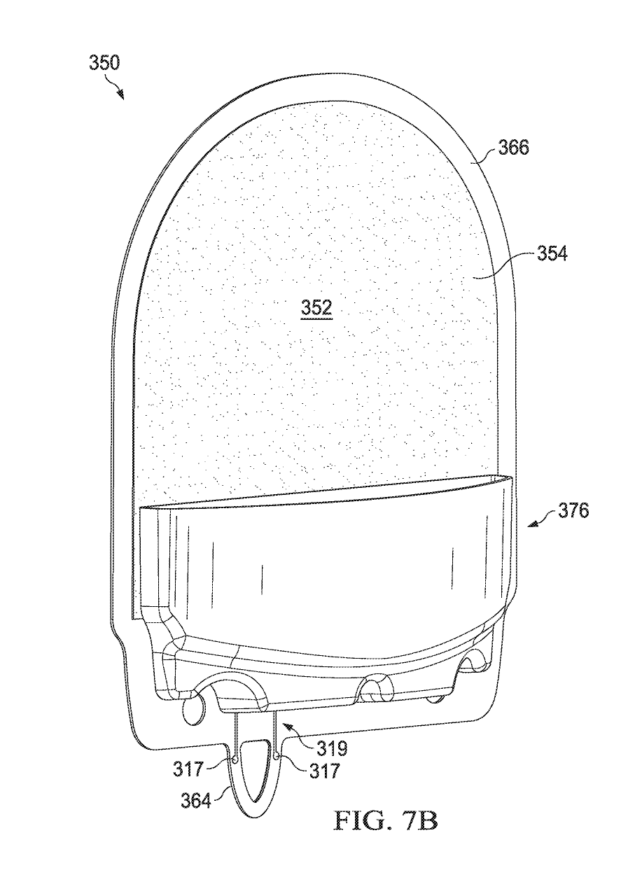

Turning now to alternative insert configurations, FIGS. 6A-6B and 7A-7B depict example inserts 250 and 350 that each include onboard light sources. Such insets 250 and 350 may be used with bases of insect trapping devices that do not have light sources. FIGS. 6A-6B depict isometric views of an example insert 250 that does not include a reservoir. Similar to the insert 150 described herein, the insert 250 has an adhesive portion 252 that is surrounded by a frame 266 and having a front face 254 to trap insects thereon. The insert 250 also has a light source 214, which is shown to include a set of LEDs 216. The LEDs 216 are positioned such that they are behind the adhesive portion 252 (relative to an observer of the device) during operation of the associated insect trapping device, and a rear face 256 of the adhesive portion 252 is illuminated upon activation of the LEDs 216. The insert 250 has a ledge 215 having a leading edge 217 which may mirror the shape of the front surface of a shroud of an associated base. The insert 250 also has a downwardly depending tab 264 extending from a lower portion of the insert 250. The vertical centerline of the downwardly depending tab 264 is offset from the vertical centerline of the insert 250 and is positioned to be received into a switch of a corresponding base. The downwardly depending tab 264 also has electrical contacts 217 that are positioned to come into electrical contact with corresponding contacts in a base of an insect trapping device. Once in electrical contact with a base, power can be provided through the electrical contacts 217 and circuitry 219 to illuminate the light source 214 and/or other attractants that may be onboard the insert 250.

FIGS. 7A-7B show isometric views of an insert 350 that is similar to the insert 250, except that the insert 350 includes a reservoir 376. Similar to the insert 250, the insert 350 has an adhesive portion 352 that is surrounded by a frame 366 and having a front face 554 to trap insects thereon. The insert 350 also has a light source 314, which is shown as a set of LEDs 316. The LEDs 316 are positioned on the opposite side of the insert 350 from the reservoir 376, such that once the insert 350 is slid into a shell, the LEDs 316 are positioned behind the adhesive portion 352 (relative to an observer of the device) to illuminate its rear face 356. The insert 350 has a ledge 315 having a leading edge 317 which may mirror the shape of the front surface of a shroud of an associated base. The insert 350 also has a downwardly depending tab 364 extending from a lower portion of the insert 350, which has electrical contacts 317, similar to the arrangement as described above in FIGS. 6A-6B. Once in electrical contact with a base, power can be provided through the electrical contracts 317 and circuitry 319 to illuminate the light source 314 and/or other attractants that may be onboard the insert 350.

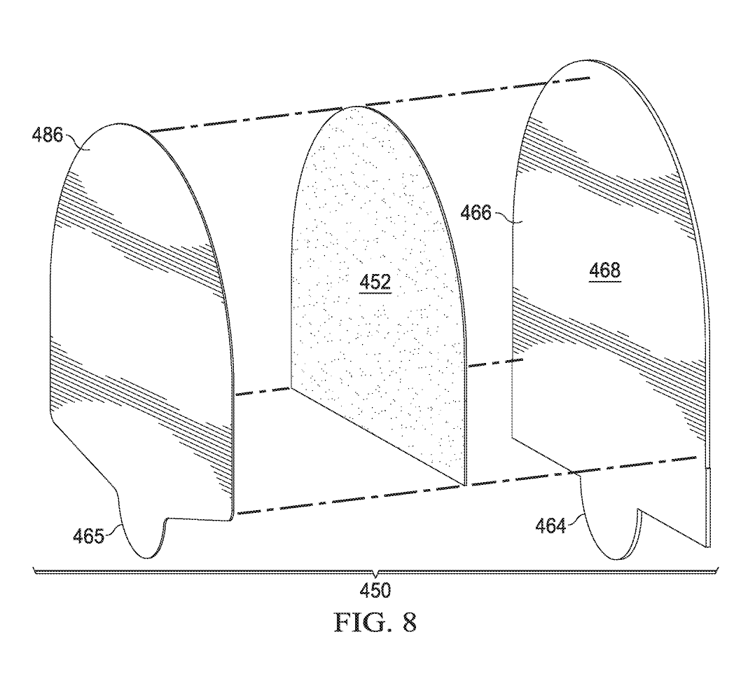

While the inserts described above utilize a frame construction, this disclosure is not so limited. FIG. 8 depicts an exploded view of an insert 450 having a frameless configuration. As shown, an adhesive portion 452 is affixed to a substantially solid base member 468. The base member 468 can be, for instance, semi-rigid card stock, or other suitable material. Nevertheless, the solid base member 468 can allow for the adhesive portion 452 to be heated in accordance with the temperature parameters described above. The base member 468 can include a downwardly depending tab 464 that can function to provide a gripping point for the user and also be used to activate a switch in an insect trapping device. While FIG. 8 illustrates that the vertical centerline of the downwardly depending tab 464 is generally aligned with a vertical centerline of the base member 468, in other configurations the vertical centerline of the downwardly depending tab 464 is offset from the vertical centerline of the base member 468. Further, while FIG. 8 depicts the adhesive portion 452 being positioned on a first side of the base member 468, this disclosure is not so limited. In some configurations, for instance, a second adhesive portion is affixed to the second side of the base member 468. Such configuration (sometimes referred to as a doubled-sided insert) may allow for the insert 450 to be removed from a shell, flipped by the user, and then re-inserted into the shell for future use. Also, shown in FIG. 8 is a releasable liner 486 that can be affixed to the base member 468 to cover and protect the adhesive portion 452 prior to use. As with other inserts described herein, the releasable liner 486 can be added to the insert 450 (and/or a reservoir of the insert) during manufacture such that the insert 450 is packaged and shipped with the releasable liner 486 covering the adhesive portion 452. Immediately prior to inserting the insert 450 into a shell of an insect trapping device, the user can remove and dispose of the releasable liner 486 to expose the adhesive portion 452 and prepare the insert 450 for use. In the illustrated configuration, the releasable liner 486 includes a tab 465 that is disconnected from the base member 468 to provide a grip point for the user.

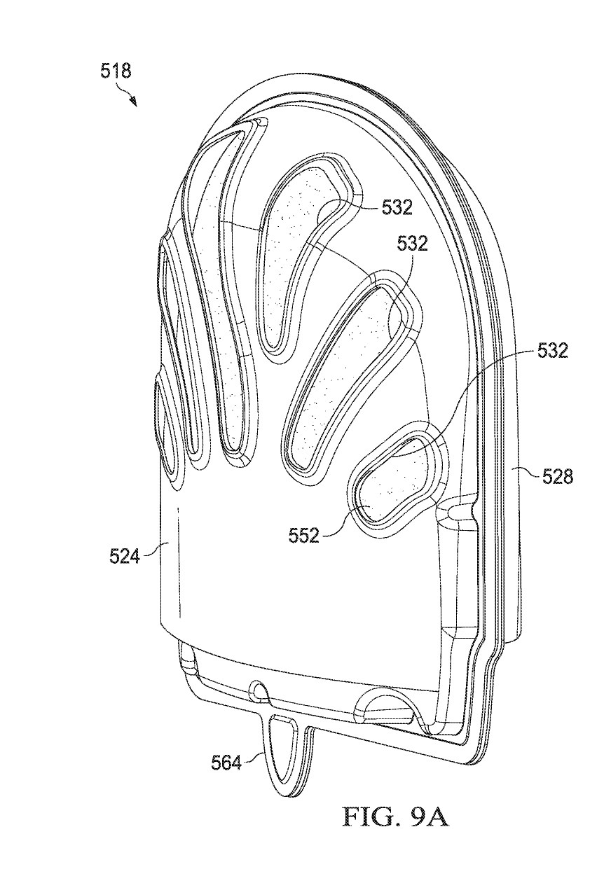

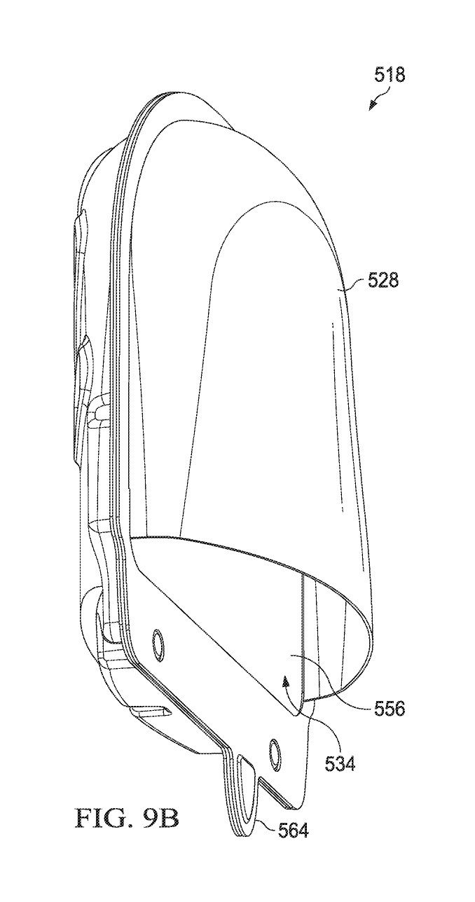

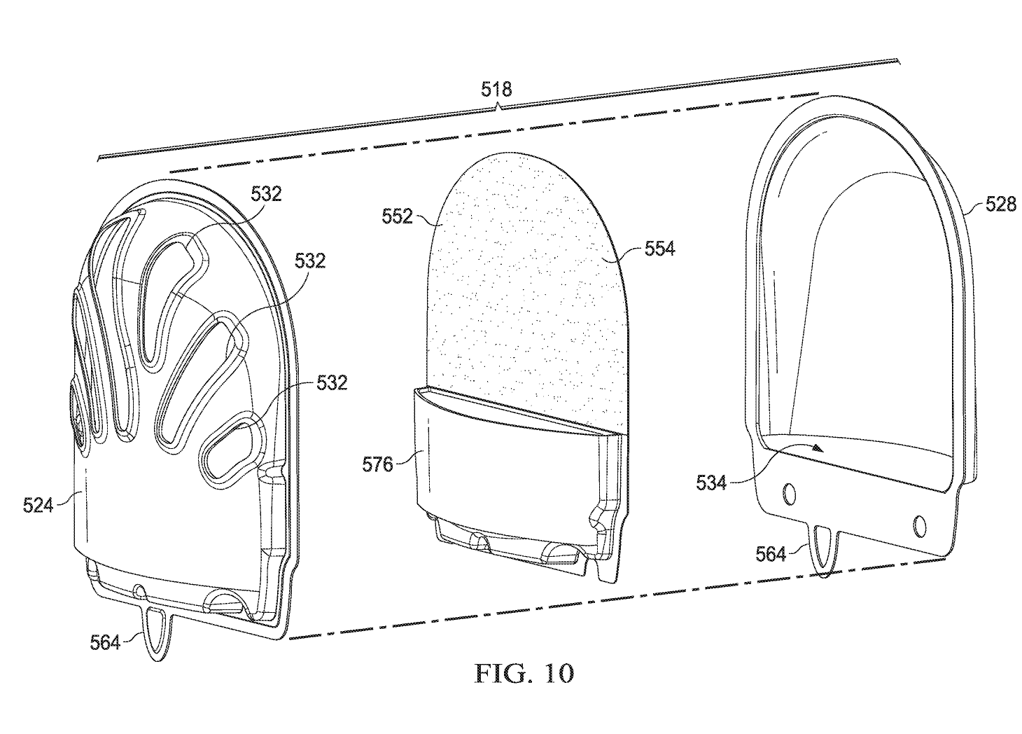

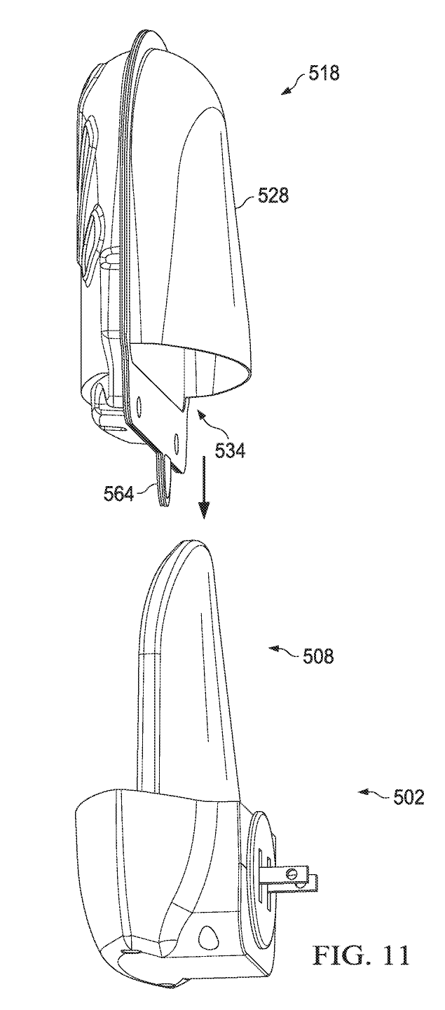

Turning now to alternative cartridge configurations, FIGS. 9A-13B depict example cartridges 518 and 618 that have adhesive portions non-removably positioned inside the cartridge. As such, the cartridge may be affixed to a base of an insect trapping device, and then subsequent to use, the entire cartridge may be removed and disposed of by the user. A fresh cartridge may then be affixed to the base and operation of the insect trapping device can be resumed. FIGS. 9A-9B depict isometric views of an example cartridge 518 which may be used with the base depicted in FIG. 11. FIG. 10 depicts an exploded view of the cartridge 518 to illustrate one example configuration of an adhesive portion 552 and a reservoir 576. The reservoir 576 can be similar to the reservoir 176 described above with respect to insert 150. It is noted, however, that some configurations do not include the reservoir 576. The cartridge 518 can be similar to or the same in many respects as the cartridge 118. For example, a front housing 524 of the cartridge 518 can define one or more openings 532 for receiving a flying or crawling insect such that they will come in contact with a front surface 554 of the adhesive portion 552. The adhesive portion 552 of cartridge 518, however, is non-removably positioned between the front housing 524 and a rear housing 528 and divides the interior of the cartridge into a front cavity 588 and a rear cavity 574, as shown in FIG. 12. The front housing 524 and the rear housing 528 and/or the adhesive portion 552 can be coupled using any suitable technique, such as ultrasonic welding, adhesives, mechanical fasteners, and the like. Alternatively, the front housing 524 and the rear housing 528 can be a unitary structure formed by injection molding, for example. As shown in FIG. 9B, the rear housing 528 can be convex and spaced apart from a rear face 556 of the adhesive portion 552 at the bottom of cartridge 518 such that they collectively define a bottom opening 534. The cartridge 518 can further include a downwardly depending tab 564 to engage a switch on the base 502 (FIG. 11).

FIG. 11 illustrates the cartridge 518 being coupled to the base 502. FIG. 12 is a lateral cross-sectional view of the cartridge 518 (FIG. 11) and the base 502 taken through at the geometric center of the shroud 508 subsequent to the coupling of the cartridge 518 to the base 502. The base 502 can be similar to or the same in many respects as the base 102. For example, the base 502 can include a shroud 508 having a front surface 504 that is positioned proximate to a metal plate 558. A planar front surface 561 of a PTC heating element 560 can be coupled to the metal plate 558, such that when the PTC heating element 560 is activated, the metal plate 558 is heated. In this configuration, the PTC heating element 560 is held to the metal plate 558 via a clip 511.

As shown in FIGS. 11-12, the shroud 508 can be received through the bottom opening 534 of the cartridge 518 and into the rear cavity 574 of the cartridge 518, the rear cavity 574 being defined by the rear face 556 of the adhesive portion 552 and the inner surface 531 of the rear housing 528. A front cavity 588 is defined between the front face 554 of the adhesive portion 552 and the inside surface 533 of the front housing 524. Once the cartridge 518 is fully seated, the adhesive portion 552 will be positioned adjacent the front surface 504 of the shroud 508. An inner cavity 562 is defined between the rear face 556 of the adhesive portion 552 and the front surface 504 of the shroud 508. The inner cavity 562 is part of the rear cavity 574. The rear cavity 574, the front cavity 588, and the inner cavity 562 can be warmed by the heat generated by the PTC heating element 560 during operation, although the rear cavity 574 will typically be hotter than the front cavity 588. LEDs 516 are positioned within the inner cavity 562, such that, when activated they illuminate the rear surface 556 of the adhesive portion 552 and the front surface 504 of the shroud 508. Similar to the front surface 104 described above, the front surface 504 of the shroud 508 can include roughened portions to aid in light distribution within the inner cavity 562. During operation, insects enter the front cavity 588 through the openings 532 in the front housing 524.

In some configurations, the total interior volume of the rear cavity 574, which includes any volume occupied by the shroud 508, is between about 75 cm³ and 150 cm³. The volume of the shroud 508 may be between about 25 cm³ and 100 cm³. The air gap volume, which is the total interior volume of rear cavity 574 minus the volume of the shroud 508, may be between about 37 cm³ and 120 cm³. In some configurations, the air gap volume is about 20% to 80% of the total interior volume of the rear cavity 574. In some configurations, the air gap is 65% of total interior volume of the rear cavity 574 and 35% is the volume of the shroud 508. As provided above, the air gap can serve to enhance the thermal stability of the heated surface of the adhesive portion 552.

In the illustrated configuration, due to the concave geometry of the front surface 504 of the shroud 508 and the planar adhesive portion 552, a gap (G1) is defined between the rear face 556 of the adhesive portion 552 and the front surface 504 of the shroud 508 at the center of the shroud 508. A gap (G2) is defined between the rear face 556 of the adhesive portion 552 and the front surface 504 at the side edges of the shroud 508. The length of gap (G1) is greater than the length of gap (G2). The gap (G1) can be between about 5 mm and about 12 mm and the gap (G2) can be between about 0.5 mm and about 3 mm. As shown, the portion of the shroud 508 proximate to the gap (G1) is positioned closer to the PTC heating element 560 than the portion of the shroud 508 proximate to the gap (G2). As such, the portion of the shroud 508 proximate to the gap (G1) will generally be heated to a higher temperature than the portion of the shroud 508 proximate to the gap (G2). However, the adhesive portion 552 is spaced further away from the front surface 504 of the shroud 508 proximate to the gap (G1). The adhesive portion 552 is spaced closer to the front surface 504 of the shroud 508 proximate to the gap (G2). Reducing the distance between the adhesive portion 552 and the shroud 508 at the edges of the shroud 508 and increasing the distance between the adhesive portion 552 and the shroud 508 at the center of the shroud 508, can generally account for the temperature gradient between the central portion of the front surface 504 and the edges of the shroud 508. Accordingly, the adhesive portion 552 may be uniformly heated across its entire surface area. Without intending to be bound by any theory, it is believed that uniformly heating the adhesive portion 552 (i.e., avoiding localized hot spots), increases the efficacy of the insect trapping device, as it is believed that an evenly heated adhesive portion 552 more closely mimics biological tissue.

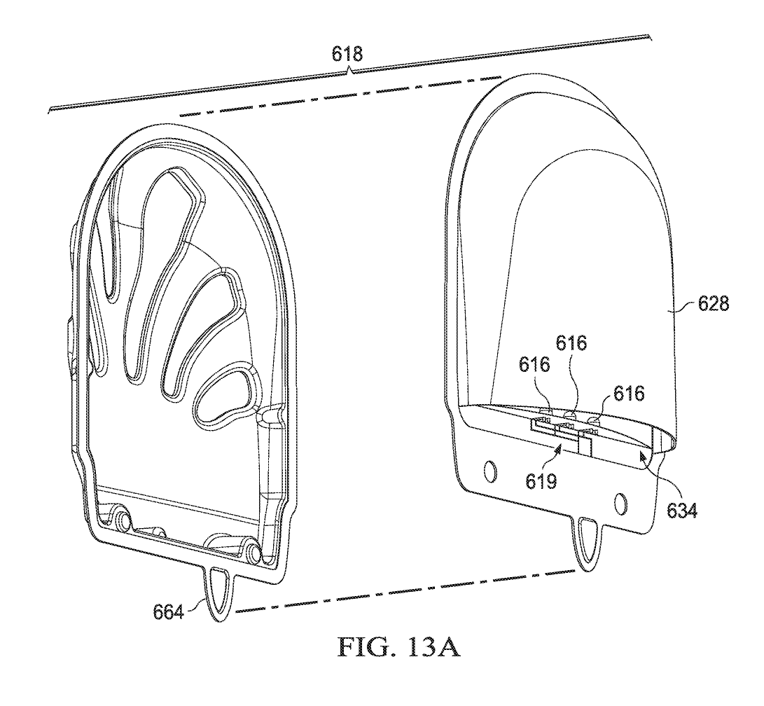

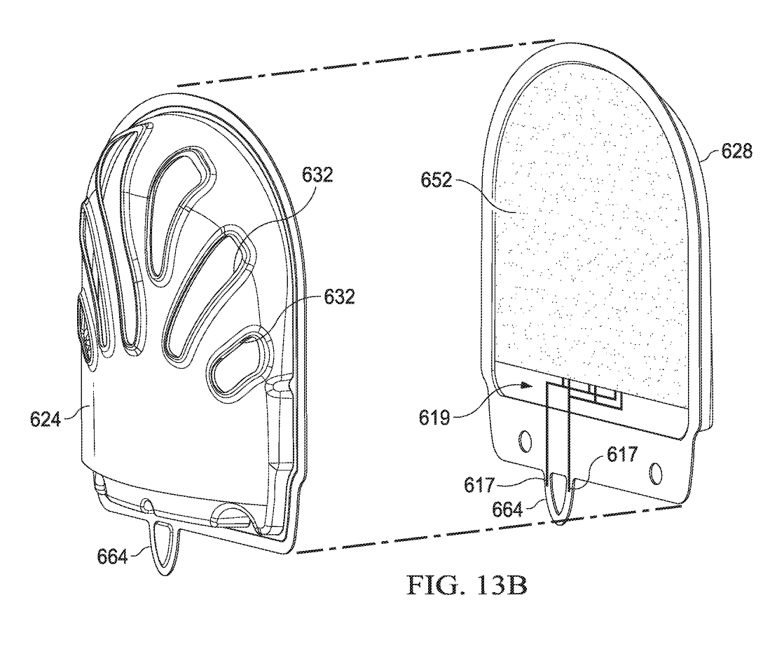

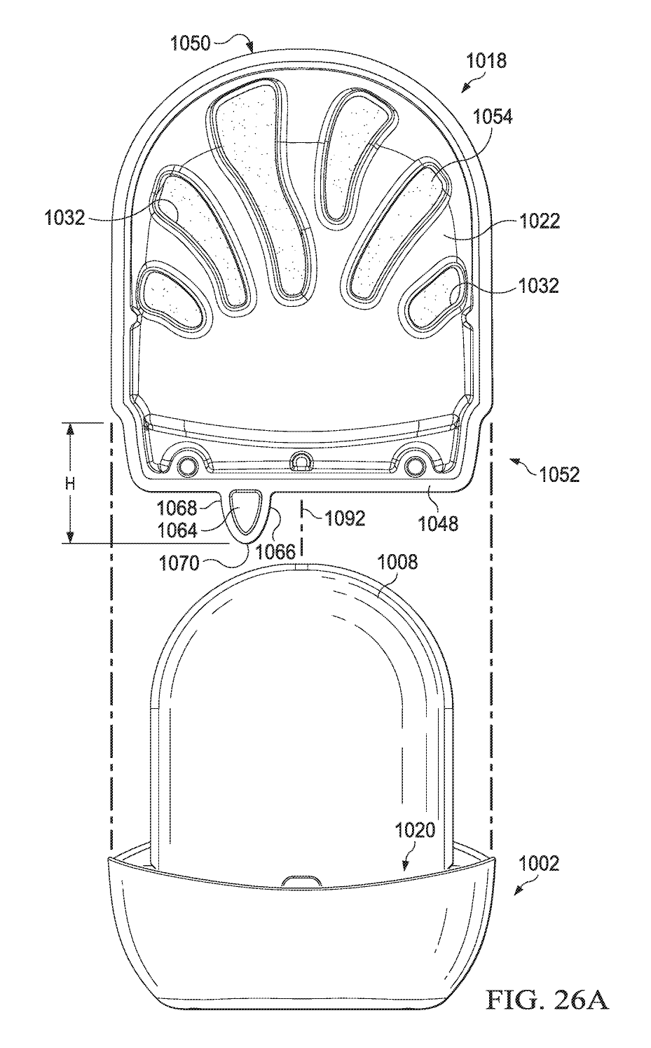

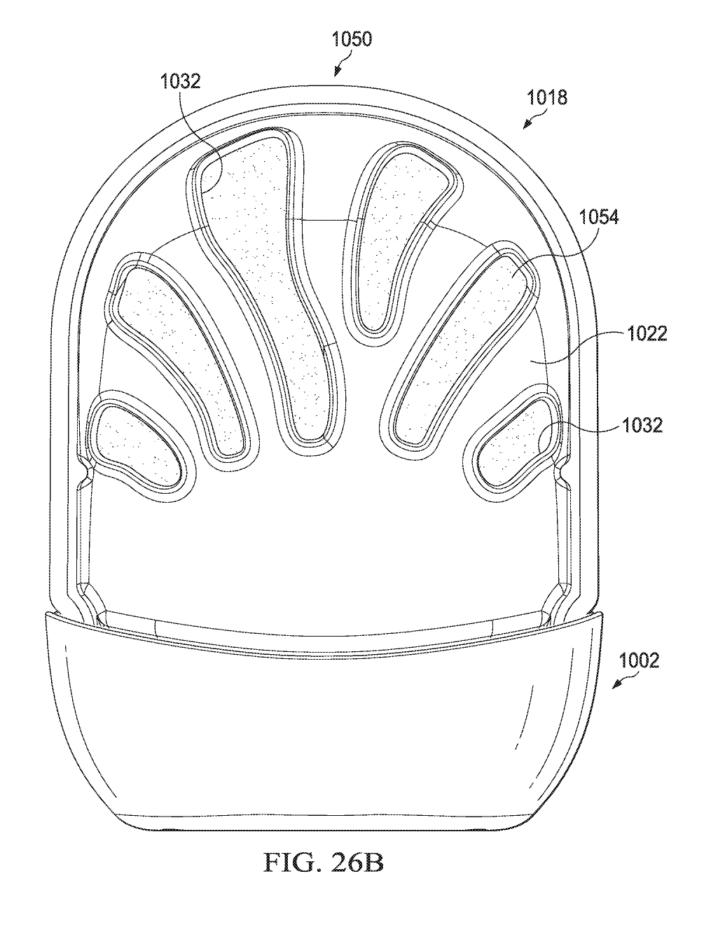

Referring now to FIGS. 13A-13B, exploded isometric views of another example cartridge 618 are illustrated. The cartridge 618 can be similar to or the same in many respects as the cartridge 518. For example, the cartridge 618 has a front housing 624 defining one or more openings 632 for receiving a flying or crawling insect. An adhesive portion 652 is non-removably mounted between the front housing and a rear housing 628. The cartridge 618 can further include a downwardly depending tab 664 to engage a switch on an associated base. Similar to the inserts 250 and 350, the cartridge 618 comprises a light source 614, which is shown to include a set of LEDs 616. The LEDs 616 are positioned such that they are behind the adhesive portion 652 during operation of an associated insect trapping device. The vertical centerline of the downwardly depending tab 664 is offset from the vertical centerline of the cartridge 618 and is positioned to be received into a switch of a corresponding base. The downwardly depending tab 664 also has electrical contacts 617 that are positioned to come into electrical contact with corresponding contacts in a base of an insect trapping device. Additional detail regarding example downwardly depending taps is provided below with regard to FIGS. 26A-33, Once in the electrical contact with a base, power can be provided through the electrical contacts 617 and circuitry 619 to illuminate the light source 614 and/or other attractants that may be onboard the cartridge 618. The cartridge 618 can be coupled to a base similar to the base 502 of FIG. 11, such that a shroud similar to shroud 508 can be received through the bottom opening 634 of the cartridge 618. The adhesive portion 652 can then be warmed in accordance with the techniques described above and the LEDs 616 can illuminate the rear surface of the adhesive portion 652.

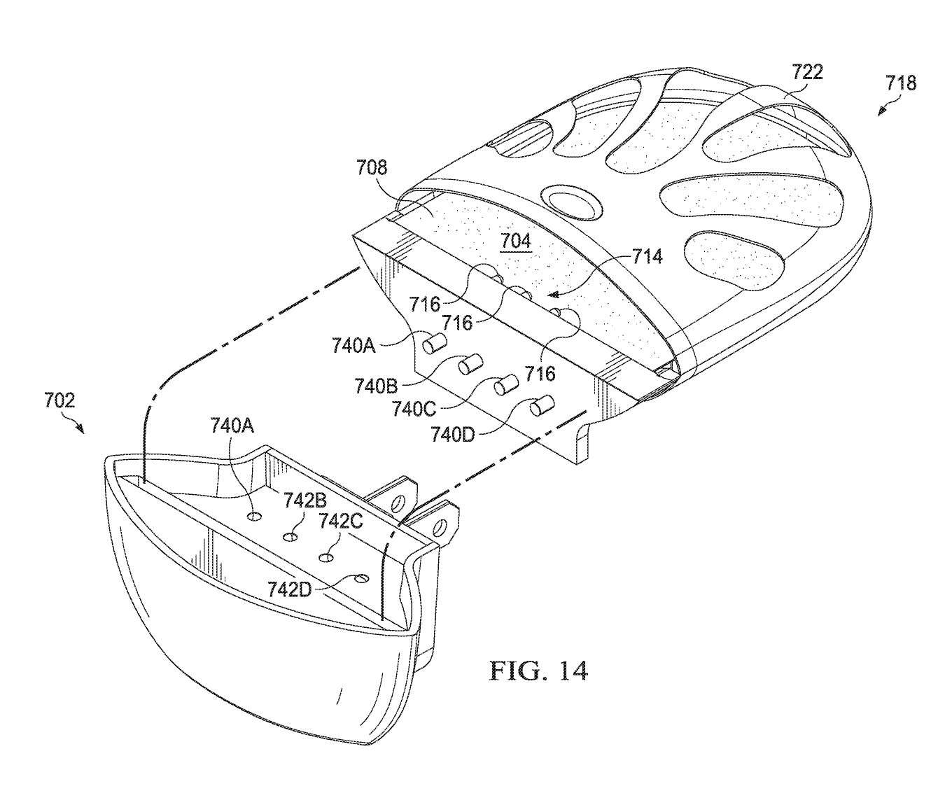

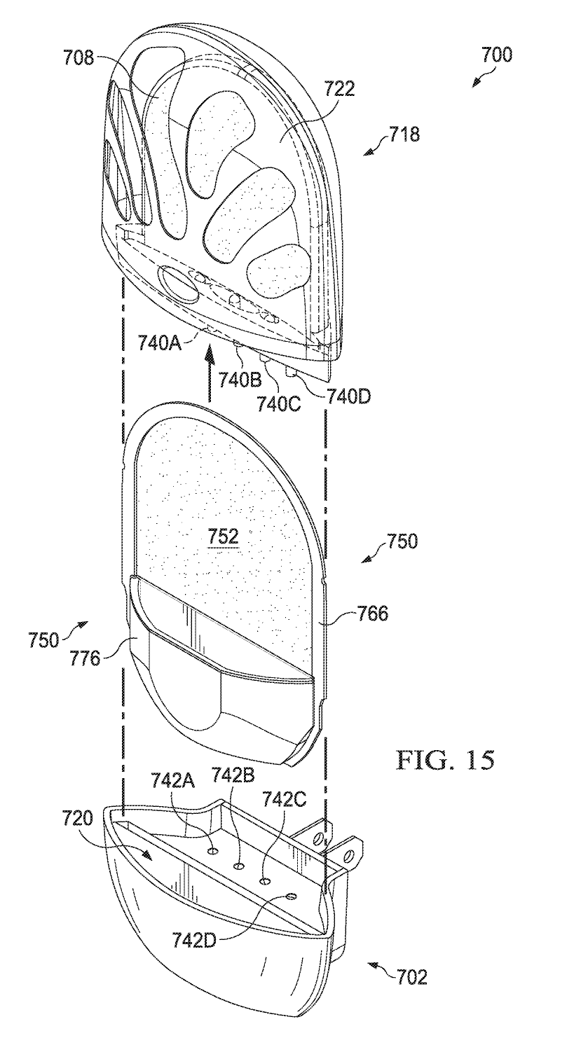

Referring now to FIGS. 14-18, additional example configurations of cartridges and bases are illustrated. In these configurations, a shell of the cartridge can non-removably house the electric heating element and/or the light source. Similar to previously described configurations, an insert can be releaseably retained at least partially in the shell such that an adhesive portion of the insert can be heated by the heating element and illuminated by a light source. FIG. 14 depicts an example cartridge 718 having a shell 722 that can be loaded with an insert 752 (FIG. 15). Once the insert is seated within the shell 722, the cartridge 718 can then be coupled to a base 702, as described in more detail below. A shroud 708 is positioned with the shell 722 and, similar to previously described configurations, one or more electric heating elements can be positioned behind a concave front surface 704 of the shroud 708. The shell also comprises a light source 714, which in the illustrated embodiment comprises three LEDs 716 positioned proximate to the base of the front surface 704. At least a portion of the front surface 704 can be roughened to aid in light diffusion, scattering, and/or reflection of the light generated by a light source 714.

The cartridge 718 can have electrical contacts 740A-D that are positioned such that they engage with respective electrical contacts 742A-D of the base 702. In some configurations, the electrical contacts 740A-D of the cartridge are pins and the electrical contacts 742A-D of the base 702 are sockets, however other configurations may be used. The total number of electrical contacts can vary based on the needs of the electrical heating element, light source, and forth, but in the illustrated cartridge 718, electrical contacts 740B and 740C are associated with circuity for the light source 714 and the electrical contacts 740A and 740D are associated with circuitry for the electric heating element. This arrangement allow for different voltage/current levels to be provided by the base 102 to electrical contacts 740B and 740C as compared to the voltage/current levels provided to electrical contracts 740A and 740D of the electric heating element.

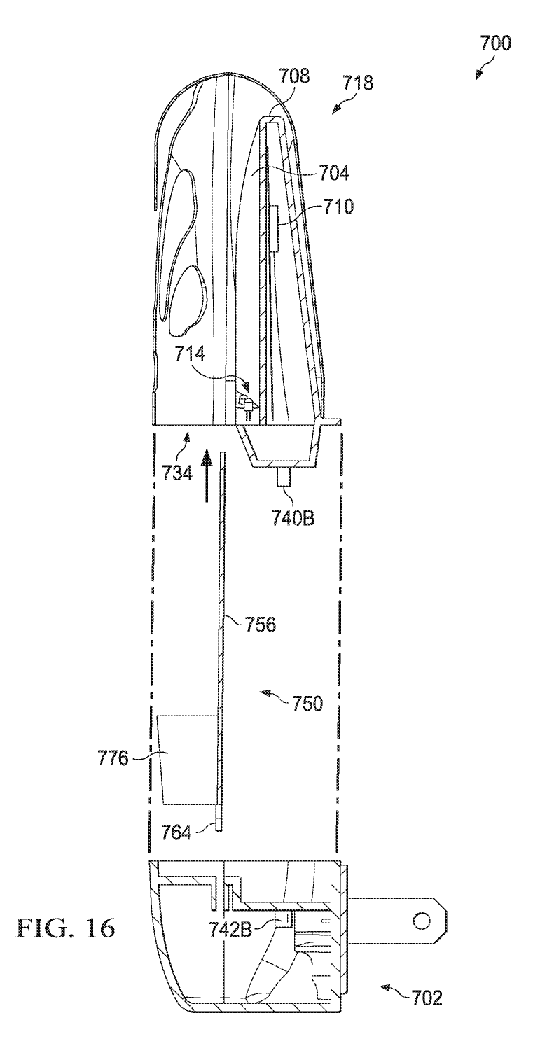

FIG. 15 depicts an exploded isometric view of an insect trapping device 700. An example insert 750 is shown being inserted into the cartridge 718 of FIG. 14 which may then be coupled to the base 702 of FIG. 14. For further clarification, FIG. 16 is a side cross-sectional view of the insect trapping device 700 of FIG. 15 taken along the vertical axis. Referring now to FIGS. 15-16, the insert 750 can be similar to previously described inserts and have a frame 766, an adhesive portion 752 and a reservoir 776. Once fully inserted into the shell 722 through the bottom opening 734 (FIG. 16), the rear face 756 of the insert 750 will be positioned adjacent the front surface 704 of the shroud 708. An electric heating element 710 is positioned behind the front surface 704 and the light source 714 is positioned between the rear face 756 of the insert 750 and the front surface 704 of the shroud 708.

To prepare the insect trapping device 100 for operation, the shell 722 with the seated insert 750 can be coupled to the base 702 by a user. As a result of the coupling, the electrical contacts 740A-D will make contact with the respective electrical contacts 742A-D of the base 702. Depending on the structure of the insert 750, the base may include a cavity 720 that is sized to receive at least a portion of the reservoir 776. Similar to previously described configurations, the insert 750 can optionally include a downwardly depending tab 764 that is positioned to engage a switch in the base 702. In such configurations, for instance, power will only be delivered to the electric heating element 710 and the light source 714 when the shell 722 is engaged to the base 702 and the switch is also activated by the downwardly depending tab 764. In this way, the electric heating element 710 and the light source 714 will only be operational when the user has properly positioned the insert 750 within the shell 722 and attached the shell 722 to the base 702.

Subsequent to use of the insect trapping device 100, the user can decouple the cartridge 718 from the base 702. The insert 750 can be removed from the shell 722 by any suitable technique, such as by squeezing certain portions of the shell 722. The shroud 708, electric heating element 710 and the light source 714 remain retained within the shell 722 when the insert 750 is removed.

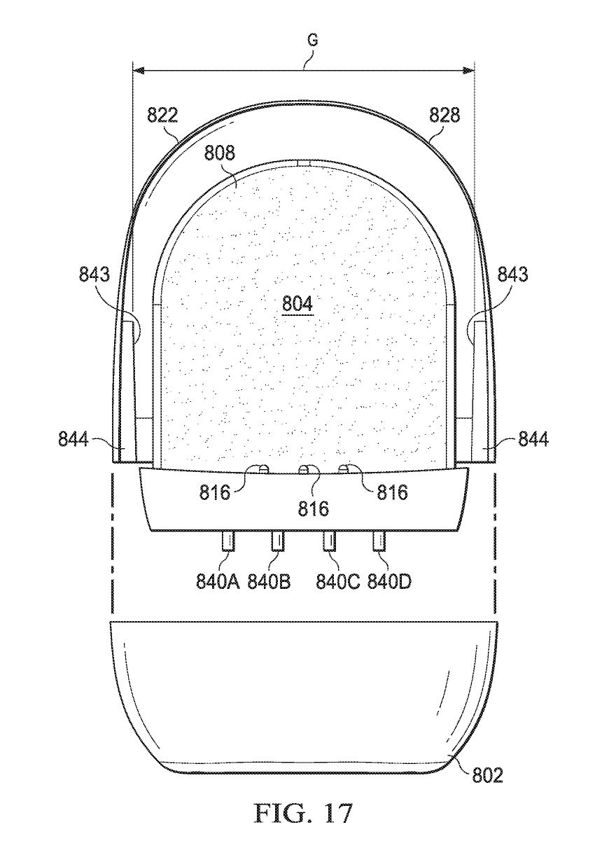

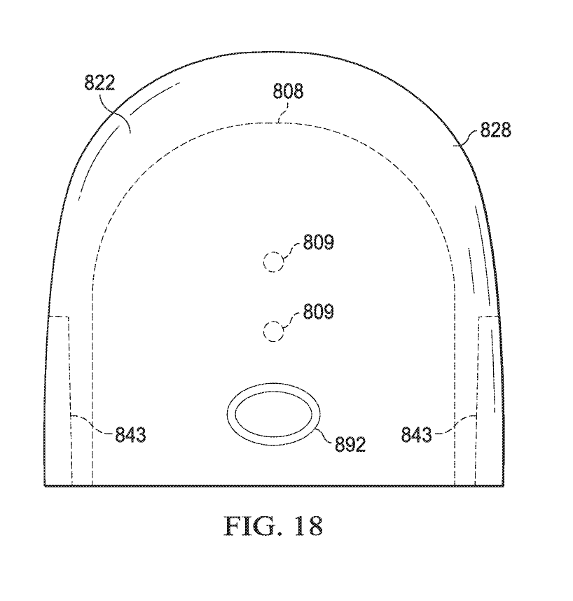

Referring now to FIGS. 17-18, another example configuration of a shell 822 is depicted. FIG. 17 shows an exploded front view of the shell 822 with an associated base 802. The front housing of the shell 822 is not shown for illustration purposes. FIG. 18 shows a rear view of the shell 822. The base 802 can be similar to the base 702 and include electrical contacts that are configured to receive the electrical contacts 840A-D of the shell 822. A shroud 808 is coupled to the rear housing 828 of the shell 822. In the illustrated configuration, two connection points 809 (FIG. 18) are used to couple the shroud 808 to the rear housing 828. As described in more detail below, these connection points 809 can help to facilitate the various flexing of the shell 822 during removal of an insert. The shroud 808 can house an electric heating element (not shown) that is configured to heat the front surface 804 of the shroud 808 during operation. Similar to other configurations, the front surface 804 of the shroud 808 can be concave and textured with LEDs 816, or other type of light source, mounted proximate to the front surface 804.

The shell 822 can also include opposing guide rails 844 extending at least partially along the inner surface of the shell 822. The inner surfaces 843 of the opposing guide rails 843 can form a gap having a width (G). The width (G) may be slightly narrower than the width of an insert, such that once an insert is slid into the shell 822, the guide rails 844 maintain the relative placement of the insert 822 via friction fit. Other techniques may be used to mechanically engage the insert with the shell 822. In order to release the insert from the shell 822, the shell 822 can be removed from the base 802 and a user can squeeze the front and/or rear surfaces of the shell 822 in order to deflect those portions inward. An example dimple 892 is shown on FIG. 18 as an example squeeze point on the rear housing 828. A similar dimple may be provided on the front housing of the shell 822. As those portions of the shell 822 deflect inward, the guide rails 843 will splay outward, thereby increasing the gap (G) and releasing the friction fit with the insert. It is noted, that the two connection points 809 of the shroud 808 to the rear housing 828 can help to facilitate the flexing of the shell 822 such that an insert can be release while also maintaining the shroud's 808 placement inside the shell 822.

Insect trapping devices in accordance with the present disclosure utilize electricity for operation. As provided above, an example insect trapping device can be inserted into a wall outlet so that various onboard attractants can be energized, such as a heating element, a light source and/or other forms of energizable attractants. Such insect trapping devices may also include various liquids, gels, or other compositions that serve to attract insects to the insect trapping device. As users will periodically interact with the device, such as to replace a spent cartridge, providing an insect device that is safe and easy to operate is paramount. For instance, in view of various onboard electric componentry, it is desirable for such electric componentry to be de-energized when a user is interacting with the device, such as when a user is removing a spent cartridge so that it can be replaced with a fresh cartridge. It is also desirable for such electric componentry to only be energized when a cartridge is properly mounted to the base. For instance, providing power to a light source only upon proper insertion of the cartridge provides beneficial operational feedback to the user. Moreover, causing the de-energization of the onboard electric componentry to occur automatically upon removal of the cartridge is also desirable to provide for ease of use and safe operation. In providing the above referenced safety benefits, it is also beneficial to provide structural features on the cartridge and base to ensure the user is inserting the cartridge into the base in the proper orientation. It is also beneficial to provide a base having a relatively compact design that minimizes the risk of foreign objects being inserted into and contacting the electrical components, some of which may involve high voltages. It also desirable to minimize the hazard posed to the electrical componentry of the base by inadvertent leakage of an attractant composition from a cartridge. As such, it is desirable to have a base that can house various circuitry to perform the operations describe above, while being safe and still having an overall compact and aesthetically pleasing form factor. In some configurations, in addition to housing various circuitry, it is desirable for the base to house at least part of an attractant reservoir while maintaining an overcall compact design and safety.

In accordance with various insect trapping devices described herein, a circuit board (i.e., circuit board 106 in FIG. 5A) is positioned within the base. Generally, the circuit board receives the power from a power source (e.g., a wall outlet) and distributes the power to the onboard components. The circuit board can be vertically mounted within the base, such that when the insect trapping device is plugged into a conventional wall outlet, the internal circuit board is generally parallel to the wall. In such an arrangement, when a cartridge having a reservoir is attached to the base, the circuit board can be positioned behind a reservoir of the cartridge (when viewing the insect trapping device from the front), such that the possibility of the insect attracting composition contacting the circuitry is minimized. Vertically positioning the circuit board also serves to provide a compact base.

The circuit board, or collection of circuit boards, can include various componentry, such as, without limitation, voltage control circuitry, capacitors, integrated circuits, resistors, and so forth. The circuit board can also include a switch that can control the supply of electricity to the onboard attractants, such as a heating element and a light source. For instance, when the switch is in a first (open) position, some or all of the onboard electrical attractants are de-energized. When the switch is in a second (closed) position, all of the onboard attractants are energized. Due to the vertical arrangement of the circuit board, the switch can be vertically oriented as well. Placement options for large components on the circuit board can be at least partially dictated by the size constraints of the internal cavity of the base and balanced with the desire to provide a compact base. As such, large components can be centrally located on the circuit board, with other lower profile components (such as a switch) laterally spaced away from the center of the circuit board. In this way, the large components can be positioned as to not interfere with mounting posts, the curvature of base, and so forth, but the overcall form factor of the base can remain generally compact.

The base can include an opening to provide access to the switch that is mounted internal to the base. In order to regulate access to the switch, the opening can be a slot that is positioned vertically above the switch. The slot can be sized to permit an elongated, substantially planar tab to pass through the slot and into the cavity of the base such that the tab can engage the switch.

However, the narrowly sized slot beneficially restricts the ability of other foreign objects to be passed through the slot. As provided above, the switch can be laterally spaced away from the center of the circuit board. Accordingly, the slot can be laterally offset from a centerline of the base as well. The substantially planar tab can be laterally offset from the centerline of the cartridge so that it aligns with the slot and switch when the user attaches the cartridge to the base.

In some cases, the tab that is passed through the slot may have a certain amount of flex, due it its relatively thin profile and length, for example, that accommodates the narrow slot and switch placement. As such, the housing of the base can include one or more vertical guiderails that are positioned proximate to the switch such that when the tab is passed through the slot, the guiderails bias the tab toward the switch. When fully inserted, the tab can be positioned between the switch and the guiderails. The guiderails can be positioned and configured to ensure the tab sufficiently engages the switch, despite its relatively thin profile and flexibility. The guiderails can be positioned laterally offset from the centerline of the base so that they are proximate to the switch. Such lateral displacement can also assist with providing for a compact base, as the guiderails can be offset from large componentry mounted to the circuit board, such as capacitors, voltage regulators, transformers and the like that may project substantially away from the circuit board.

As described in more detail below, the tab can extend from a cartridge, such that when a user mounts the cartridge to the base, the tab is passed through the slot and closes the switch. In order to properly align with the switch and the slot, the tab is laterally offset from a longitudinal centerline of the cartridge. In addition to accommodating the beneficial features of the base described above, laterally offsetting the tab ensures the proper orientation of the cartridge relative to the base during mounting. In addition to providing an offset tab that depends from the cartridge, the cartridge can also include a relatively large bottom opening that receives an upstanding shroud of the base, which in some embodiments may contain an electrical heating element. As such, in some configurations, the bottom opening generally extends across the lateral width of the cartridge.

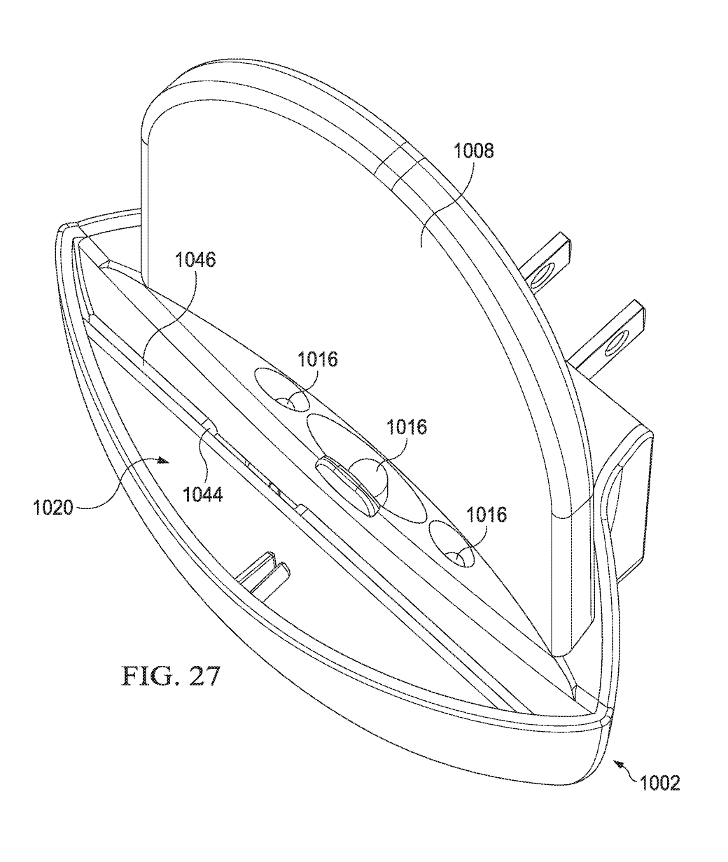

FIGS. 26A-26B depict an attachment of an example cartridge 1018 to an example base 1002. FIG. 27 is an isometric view of the base 1002 shown in FIGS. 26A-26B. Referring now to FIGS. 26A, 26B and 27, for illustration purposes, the cartridge 1018 is shown to be configured similarly to cartridge 518 shown in FIGS. 9A, 9B, and 10, although this disclosure is not so limited.

The cartridge 1018 has a distal end 1050 (i.e., towards the top) and proximal end 1052 (i.e., towards the bottom). The base 1002 can define a cavity 1020 that is sized to receive the proximal end 1052 of the cartridge 1018 when the cartridge 1018 is attached to the base 1002 (FIG. 26B). The proximal end 1052 can have a height (H) from about 25 mm to about 35 mm, as measured from the bottom most point 1070 of the tab 1064 to the highest point of the proximal end 1052. The height (H) of the proximal end 1052 can be correlated to the depth of the cavity 1020. Similar to the cartridges described above, the cartridge 1018 can include an elongate enclosure 1022 for receiving insects. The cartridge 1018 can also include an adhesive surface 1054 for trapping insects that enter through openings 1032. The cartridge 1018 defines a longitudinal centerline 1092 dividing the cartridge 1018 into lateral sides. For symmetrical cartridges, the longitudinal centerline will divide the cartridge into two symmetrical halves. For asymmetrical cartridges, the longitudinal centerline passes vertically (i.e., with respect to the configuration of the cartridge when mounted to a base and plugged into a conventional wall outlet) through its geometric center.

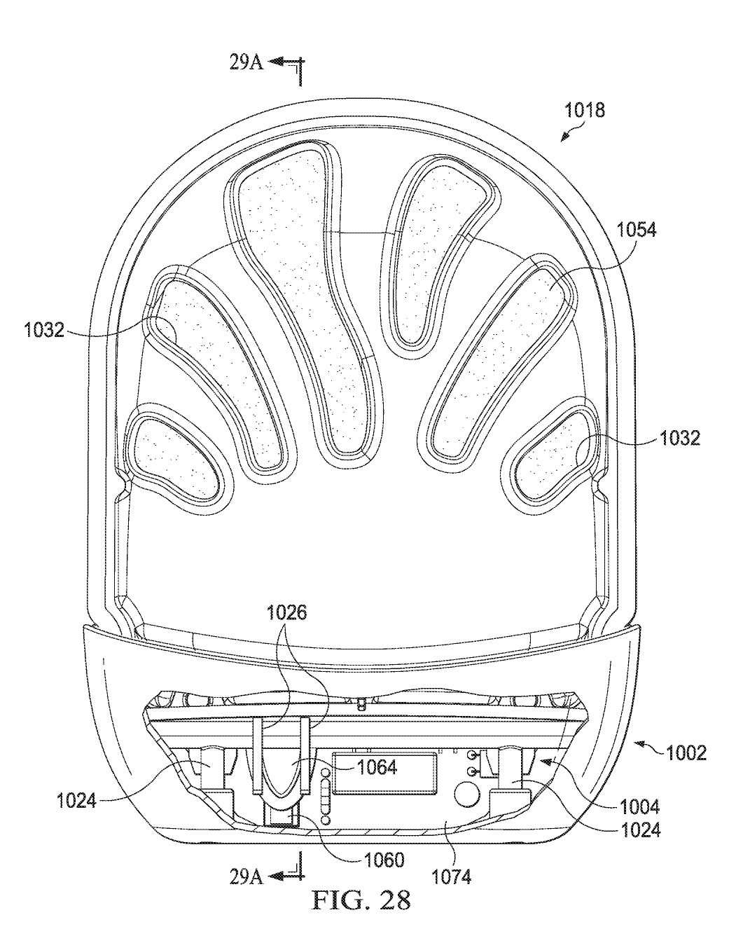

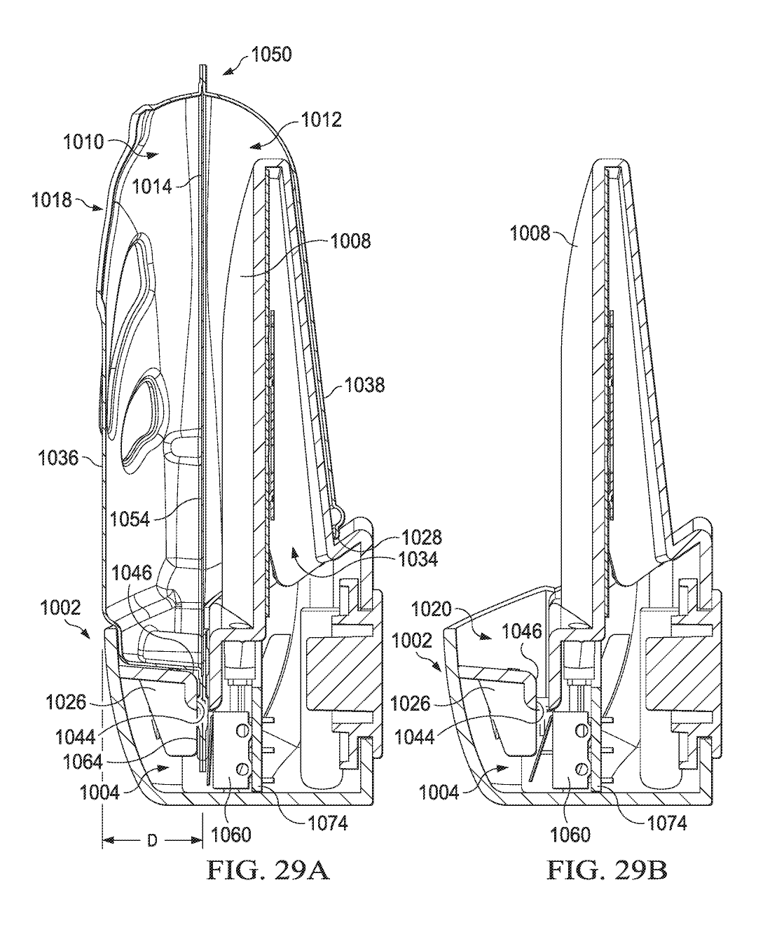

The base 1002 can also have an upstanding shroud 1008 that houses a heating element (not shown). The upstanding shroud 1008 can be received into a bottom opening 1034 (FIG. 29A) of the cartridge 1018 when the proximal end 1052 of the cartridge 1018 is inserted into the base 1002. The base 1002 can also include other attractants, such as one or more LEDs 1016.

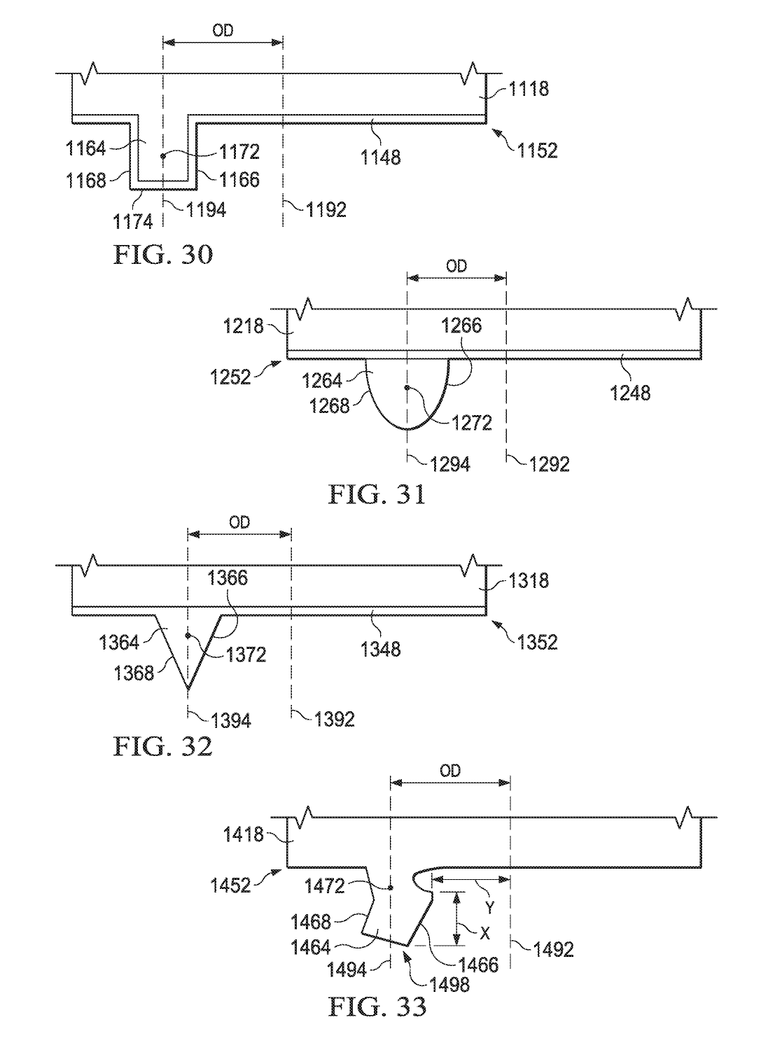

As shown in FIG. 26A, the proximal end 1052 can include a substantially planar, longitudinally extending tab 1064. The tab 1064 can have a first side edge 1066 on one side and a second side edge 1068 on the other side. Depending on the configuration of the tab 1064, the first side edge 1066 and the second side edge 1068 can converge at a most proximal point 1070 of the tab 1064, as depicted in FIG. 26A, or otherwise be connected by a proximal surface (see e.g., proximal edge 1174 in FIG. 30). The tab 1064 is positioned relative to the cartridge 1018 such that it is laterally offset from the longitudinal centerline 1092 of the cartridge 1018. As shown, due to this lateral offset of the tab 1064, the longitudinal centerline 1092 does not overlap any portion of the tab 1064. In this regard, the first side edge 1066 and the second side edge 1068 of the tab 1064 are each laterally offset (i.e. space apart) from the longitudinal centerline 1092 of the cartridge 1018. Due to the width of the tab 1064, the second side edge 1068 is laterally offset from the longitudinal centerline 1092 further than the first side edge 1066. Furthermore, since the first side edge 1066 and the second side edge 1068 are offset in the same lateral direction, both the first side edge 1066 and the second side edge 1068 of the tab 1064 are positioned on the same lateral side of the cartridge 1018.

Referring now to FIG. 27, a slot 1044 is shown to be positioned within the cavity 1020 of the base 1002. In the illustrated configuration, a groove 1046 laterally extends across the cavity 1020 and is sized to receive a rib 1048 (FIG. 26A) of the cartridge 1018 when the proximal end 1052 is inserted into the cavity 1020. As is to be appreciated however, some cartridges do not have a rib, and as such, an associated base may not necessarily have a groove 1046. The slot 1044 is positioned within the groove 1046 and is oriented above a switch 1060 (FIG. 28) that is positioned within the base 1002, which is described in more detail below. The slot 1044 is a generally narrow slit opening, having a width that is substantially greater than its depth. The slot 1044 is sized to allow the tab 1064 to pass therethrough during attachment of the cartridge 1018 to the base 1002. In order to provide proper alignment with the tab 1064, the slot 1044 is laterally offset from a centerline (not shown) of the base 1002. The position of the slot 1044 ensures that the proximal end 1052 can only be fully inserted into the cavity 1020 if the cartridge 1018 is properly aligned relative to the base 1002.

FIG. 28 depicts a partial cutaway view of a chamber 1004 defined by the base 1002 with the cartridge 1018 installed. A circuit board 1074 is shown to be vertically oriented within the base 1002. Various electrical components are coupled to the circuit board 1074 that extend away from the circuit board 1074 and into the chamber 1004. Larger components can be centrally positioned on the circuit board 1074 due to size constraints and to eliminate interference with other obstructions within the chamber 1004. For instance, larger components can be laterally placed between mounting posts 1024. The tab 1064 of the cartridge 1018 is shown to extend into the chamber 1004 through the slot 1044 (FIG. 27). The tab 1064 is shown contacting a switch 1060 that is coupled to the circuit board 1074, thereby closing the switch 1060. The switch is oriented vertically so that the elongate tab slidingly engages a lever, or other type of actuator, of the switch to close the switch. Closing the switch 1060 energizes various components of the base 1002, such as a heating element and a light source.

The base 1002 can also include one or more guiderails 1026 that are positioned opposite to and outwardly spaced from the switch 1060. The guiderails 1026 can be configured such that when the tab 1064 is passed through the slot 1044, the guiderails 1026 bias the tab 1064 against the switch 1060, which might otherwise flex outwardly due to its thin and elongate configuration. In some configurations, the guiderails 1026 are unitary with the base 1002.

FIG. 29A is a cross-sectional view of the base 1002 and the cartridge 1018 taken along line 29A-29A in FIG. 28. FIG. 29B is a cross-sectional view of the base 1002 with the cartridge 1018 removed. Referring first to FIG. 29A, the tab 1064 of the cartridge 1018 is shown activating the switch 1060, which is vertically mounted to the circuit board 1074. In this configuration, the tab 1064 is positioned generally midway between a front surface 1036 of the cartridge 1018 and a rear surface 1038. Further, the guiderails 1026 of the base 1002 are shown biasing the tab 1064 toward the switch 1060 to ensure proper activation. FIG. 29A further illustrates at the proximal end 1052 (FIG. 26A) can be fully received into the cavity 1020 when the cartridge 1018 is attached to the base 1002. The proximal end 1052 can also be inwardly recessed from the front surface 1036. The depth (D) of the proximal end 1052 can be, for example, from about 12 mm to about 18 mm.

Similar to cartridges described above, such as cartridge 518, the cartridge 1018 has a bottom opening 1034 at least partially defined by a rear edge 1028. The shroud 1008 can be received through the bottom opening 1034 when the cartridge 1018 is attached to the base 1002. The bottom opening 1034 can extend substantially from one lateral side edge of the cartridge 1018 to the opposite side edge of the cartridge 1018, similar to the bottom opening 534 shown in FIG. 9B. In some embodiments, the bottom opening 1034 can have a lateral width from about 70 mm to about 80 mm and a depth from about 20 mm to about 30 mm. The lateral width is the lateral measured between opposing sides of the bottom opening when projected onto a bottom planar view. The depth is measured from the front to the back of the rear opening when projected onto a bottom planar view. The cartridge 1018 can have a front enclosure 1010 and a rear enclosure 1014. A divider 1012 can divide cartridge 1018 into the front enclosure 1010 and the rear enclosure 1012. In some embodiments, the divider 1012 comprises the adhesive surface 1054. Referring now to FIG. 29B, with the cartridge 1018 removed, the switch 1060 is shown in the open position, thereby de-energizing the onboard attractants.

It is to be appreciated that a variety of tab configurations can be utilized without departing from the scope of the present disclosure. For instance, the size, location, and structure of the tab may vary. For illustration purposes, a variety of different example tab configurations are depicted in FIGS. 30-33. Referring first to FIG. 30, a lowermost portion of a proximal end 1152 of a cartridge 1118 is shown, with the cartridge 1118 having a longitudinal centerline 1192. The longitudinal centerline 1192 divides the cartridge 1118 into lateral sides. The proximal end 1152 has a laterally extending rib 1148. The rib 1148, for instance, can be the formed when a front portion and a rear portion of the cartridge 1118 are joined via glue, ultrasonic welding, or other coupling technique. The proximal end 1152 includes an elongated, substantially planar tab 1164.

In this configuration, the rib 1148 generally follows the contours of the tab 1164, such that it defines the periphery of the tab. The tab 1164 has a first side edge 1166 and a second side edge 1168. Due to the configuration of the tab 1164, a proximal edge 1174 connects the first side edge 1166 and a second side edge 1168, such that the periphery of the tab 1164 is collectively defined by the first side edge 1166, the proximal edge 1174, and the second side edge 1168.

In this configuration, the lateral width of the tab 1164 is defined as the distance between the first side edge 1166 and a second side edge 1168. The lateral width of the tab 1164 can be less than 25% of the lateral width of the entire proximal end 1152, for example. The lateral width can be from about 1 mm to about 14 mm, preferably from about 5 mm to about 13 mm, and a longitudinal length from about 8 mm to about 50 mm, preferably from about 10 mm to about 18 mm. A longitudinal length of the tab 1164 can be about 8 mm to about 50 mm, preferably from about 10 mm to about 18 mm. The tab 1164 can have a maximum thickness from about 0.05 mm to about 3 mm preferably from about 1 mm to about 2 mm. The tab 1164 defines a longitudinal centerline 1194 that extends vertically through a geometric center 1172 of the tab 1164 and is parallel to the longitudinal centerline 1192. Since the tab 1164 is symmetric, the longitudinal centerline 1194 divides the tab 1164 into two symmetrical halves. The longitudinal centerline 1194 of the tab 1164 is offset from the longitudinal centerline 1192 of the cartridge 1118 by an offset distance (OD). In some configurations, offset distance (OD) is the range of about 11 mm to about 15 mm. As shown, due to this offset distance (OD), the longitudinal centerline 1192 does not overlap any portion of the tab 1164. The first side edge 1166 and the second side edge 1168 of the tab 1164 are each laterally offset (i.e., spaced apart) from the longitudinal centerline 1192 of the cartridge 1118. Due to the width of the tab 1164, the second side edge 1168 is laterally offset from the longitudinal centerline 1192 further than the first side edge 1166. Furthermore, since the first side edge 1166 and the second side edge 1168 are offset in the same lateral direction, both the first side edge 1166 and the second side edge 1168 of the tab 1164 are positioned on the same lateral side of the cartridge 1118.

Referring now to FIG. 31, a lowermost portion of a proximal end 1252 of a cartridge 1218 is shown, with the cartridge 1218 having a longitudinal centerline 1292. The longitudinal centerline 1292 divides the cartridge 1218 into lateral sides. The proximal end 1252 has a laterally extending rib 1248. The proximal end 1252 includes an elongated, substantially planar tab 1264. In this configuration, the rib 1248 generally extends laterally across the proximal end 1252 and the tab 1264 downwardly extends from the rib 148. The tab 1264 has a first side edge 1266 and a second side edge 1268, both of which are curved and converge.

In this configuration, the lateral width of the tab 1264 is defined as the distance between the first side edge 1266 and a second side edge 1268, being narrower at the proximal end (i.e., bottom) than the top end (i.e., distal end) where it meets the rib 1248. The tab 1264 defines a longitudinal centerline 1294 that extends vertically through a geometric center 1272 of the tab 1264 and is parallel to the longitudinal centerline 1292. The longitudinal centerline 1294 of the tab 1264 is offset from the longitudinal centerline 1292 of the cartridge 1218 by an offset distance (OD). In some configurations, offset distance (OD) is the range of about 11 mm to about 15 mm.

Referring now to FIG. 32, a lowermost portion of a proximal end 1352 of a cartridge 1318 is shown, with the cartridge 1318 having a longitudinal centerline 1392. The longitudinal centerline 1392 divides the cartridge 1318 into lateral sides. The proximal end 1352 has a laterally extending rib 1348. The proximal end 1352 includes an elongated, substantially planar tab 1364. In this configuration, the rib 1348 forms the entirety of the tab 1364 such that the tab 1364 is unitary with the rib 1348. The tab 1364 has a first side edge 1366 and a second side edge 1368. The tab 1364 defines a longitudinal centerline 1394 that extends vertically through a geometric center 1372 of the tab 1364 and is parallel to the longitudinal centerline 1392. The longitudinal centerline 1394 of the tab 1364 is offset from the longitudinal centerline 1392 of the cartridge 1318 by an offset distance (OD). In some configurations, offset distance (OD) is the range of about 11 mm to about 15 mm.

Referring now to FIG. 33, a lowermost portion of a proximal end 1452 of a cartridge 1418 is shown, with the cartridge 1418 having a longitudinal centerline 1492. The longitudinal centerline 1492 divides the cartridge 1418 into lateral sides. The proximal end 1452 includes an elongated, substantially planar tab 1464. In this configuration, the tab 1464 is shown to be an irregular shape. The tab 1464 has a first side edge 1466 and a second side edge 1468, each of which may be made of straight segments and curved segments, depending on the contours of the tab 1464. The tab 1464 defines a longitudinal centerline 1494 that extends vertically through a geometric center 1472 of the tab 1464 and is parallel to the longitudinal centerline 1492. The longitudinal centerline 1494 of the tab 1464 is offset from the longitudinal centerline 1492 of the cartridge 1418 by an offset distance (OD). In some configurations, offset distance (OD) is the range of about 11 mm to about 15 mm.

The tab 1464 also has a bottom portion 1498, which is the lowermost planar portion of the tab 1464. The bottom portion 1498 extends upward from the most proximal point (i.e., bottom point) distally toward the top of the tab 1464. The top edge of the bottom portion is defined by height (X). The height (X) can be at least 10 mm. The bottom portion 1498 comprises at least a portion of the first side edge 1466 and the second side edge 1468. The portion of the first side edge 1466 that is within the bottom portion 1498 is offset from the longitudinal centerline 1492 of the cartridge 1452. The portion of the first side edge 1466 that is within the bottom portion 1498 portion and that is most proximate to the longitudinal centerline 1492 of the cartridge 1418 is laterally offset by a lateral distance (Y). In accordance with various embodiments, the lateral distance (Y) can be at least 7 mm. Further the overall maximum width of the bottom portion 1498 of the tab 1464 can be about 1 mm to about 14 mm.

### Surface Temperatures Test Method

Surface temperatures of insect trapping devices are measured over three surface locations of the activated device in accordance with the following procedures. The temperature measurements are conducted using a calibrated thermocouple-based thermometer (such as the Fluke Model 51 Thermometer, as available from Fluke Corporation, Everett, Wash., U.S.A.), wherein the thermocouple probe tip has a diameter of approximately 1 mm.

The three surface locations on the insect trapping device that are specified to be measured are namely the adhesive portion, the front surface of the shroud, and the front surface of the electric heating element (see FIGS. 1-13B). Each insect trapping device is measured under two different atmospheric conditions, namely at 23° C.+/−2° C. with a Relative Humidity of 20-60% RH; and at 30° C.+/−1° C. with a Relative Humidity of 20-60% RH. Measurements are conducted only while the insect trapping device is protected from air currents and drafts since air movements may affect the results. For the purposes of this test method, a steady state temperature is defined as a surface temperature that fluctuates within a range of +/−1° C. during a monitoring period of 5 minutes, as measured by the thermocouple placed in contact with the insect trapping device at the approximate center of the specified surface.

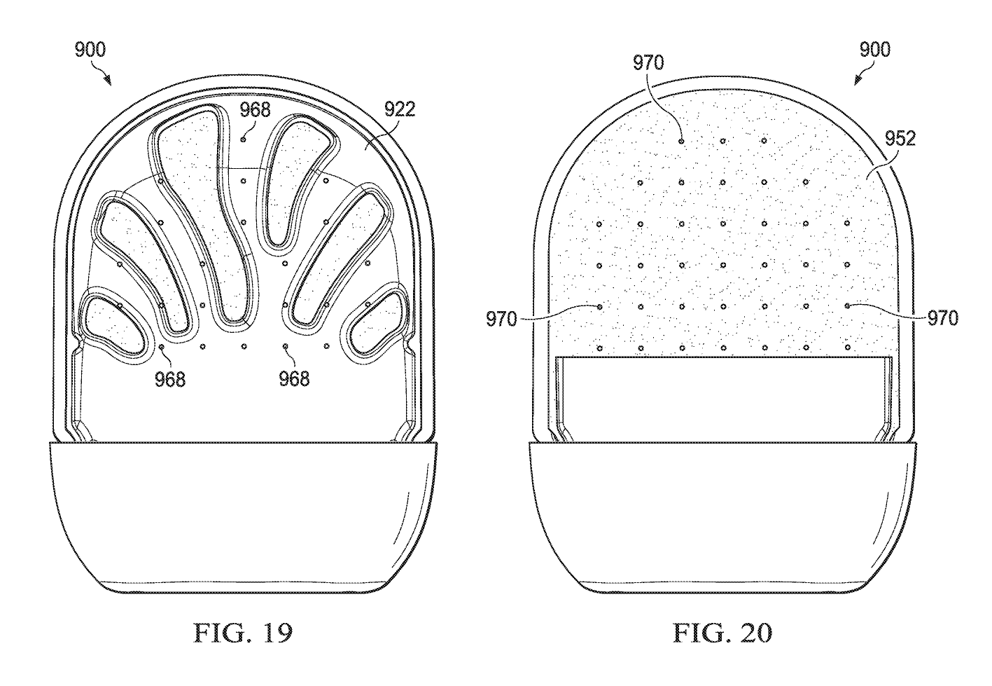

Each insect trapping device to be tested is first prepared by placing it in the 23° C. atmospheric condition specified, and removing any release liners such as those which may be associated with the insert or cartridge. The cartridge loaded with the adhesive portion is loaded onto the insect trapping device according to any instructions provided by the manufacturer. If the openings in the outer shell of the insect trapping device are insufficient in size or location to enable easy access for the thermocouple probe tip to come in contact with the areas of the adhesive portion to be measured, then the outer shell of the device is modified to provide such access. The outer shell of the device may be removed if necessary, and such modifications are made using a sharp blade to gently puncture the shell to form a plurality of small perforating slits. Each perforation comprises a pair of overlapping orthogonal slits which together form an X-pattern cut through the thickness of the shell. The slits are of the minimum length necessary to permit the thermocouple probe tip to penetrate through the shell and contact the areas of the adhesive portion to be measured. The slits are arranged in a grid-pattern with approximately 1 cm intervals over the area of the adhesive portion to be measured that is not otherwise accessible by the thermocouple probe through the shell. If the thickness and/or strength of the shell prevents the cutting of such slits, then holes slightly larger than the probe tip diameter may be drilled through the shell instead of the slit perforations. The modified shell is remounted back onto the device. If adequate access to the adhesive portion cannot be provided by modifying the shell, then the shell may be removed to provide adequate access to the areas of the adhesive portion to be measured. For illustration purposes, FIG. 19 depicts an example insect trapping device 900 showing a shell 922 subsequent to the drilling of holes 968 at approximately 1 cm intervals.

The insect trapping device is activated by and attaching the cartridge to the base and supplying electrical power to the device at the appropriate voltage as specified on the device label, or as otherwise indicated. The device is then allowed to heat up for at least 30 minutes. After 30 minutes of heating, the thermocouple thermometer is used periodically to monitor the locations of the adhesive portion to be measured, and the device is allowed to continue warming until the monitored locations reach a steady state temperature. When a steady state temperature is detected, the device is ready for measurement of the reportable surface temperatures of the adhesive portion, at the 23° C. condition.

To measure the adhesive portion at the 23° C. condition, the surface temperature is measured repeatedly in a grid pattern, such that a measurement is taken within each approximate centimeter square of the surface of the exposed adhesive area that is heated. The average value of the grid-based measurements that is directly in front of the portion of the shroud that is heated is calculated (the Steady State Average Temperature), and both the minimum and maximum values of these grid-based measurements for: (i) the entire adhesive portion that is heated, whether or not directly in front of the shroud (the Minimum Steady State Temperature and the Maximum Steady State Temperature, respectively), and (ii) the adhesive portion directly in front of the shroud (the Direct Heat Minimum Steady State Temperature and Direct Heat Maximum Steady State Temperature, respectively) are also determined. The values of these three temperature metrics are reported for the adhesive portion at the 23° C. atmospheric condition.

The device is then located in the 30° C. atmospheric condition specified, activated with electrical power, and allowed to heat for at least 30 minutes and until the adhesive portion again reaches a steady state temperature. The thermocouple-based thermometer is also allowed to equilibrate under the same atmospheric condition. The adhesive portion is then measured again using the same grid-pattern technique and calculations that were used previously, in order to determine the values of the same three temperature metrics specified previously, except this time the results are obtained and reported at the 30° C. atmospheric condition.

Before proceeding to measure the front surface of the shroud, the outer shell of the device is removed and set aside until the adhesive portion is modified as described below. If the shell cannot be temporarily removed, the front portion may be cut off in a manner that would enable it to be replaced after the required modifications of the adhesive portion. After the shell or front portion of the shell is temporarily removed, the adhesive portion is removed from the device and gently apertured with a plurality of slits or small holes in a manner similar to that described previously for the modification of the shell. Each aperture has a dimension of approximately 1 mm in diameter and is sufficient to permit the thermocouple probe to pass through the adhesive portion. Care is taken to ensure that the adhesive portion remains well attached to the supporting frame or mounts after the puncturing process. The holes are arranged across the glue sheet in a grid-pattern of approximately 1 cm intervals, at approximately the same locations which were measured previously when recording the temperatures of the adhesive portion. Each aperture should be placed in the glue sheet directly in front of the portion of the housing surface that is heated, and in alignment with the apertures of the shell after the shell is replaced. The apertured adhesive portion is reloaded into the device, and the outer shell or shell portion is replaced. For illustration purposes, FIG. 20 depicts the example insect trapping device 900 showing an adhesive portion 952 subsequent to the drilling of holes 970 at approximately 1 cm intervals and prior to the re-attachment of the shell.

The device with punctured adhesive portion is located in the 23° C. atmospheric condition specified, activated with electrical power, and allowed to heat for at least 30 minutes until the front surface of the shroud reaches a steady state temperature. The surface of the front surface of the shroud is then measured in a grid-pattern by passing the thermocouple through both the apertures in the shell (i.e., holes 968 in FIG. 19) and those in the adhesive portion (i.e., holes 970 in FIG. 20). The temperatures measured in the grid pattern are used to determine the values of the Steady State Average Temperature, the Minimum Steady State Temperature and the Maximum Steady State Temperature, except this time the results are obtained and reported from the front surface of the shroud, at the 23° C. atmospheric condition.

The device is then located in the 30° C. atmospheric condition specified, activated with electrical power, and allowed to heat for at least 30 minutes and until the front surface of the shroud again reaches a steady state temperature. The thermocouple-based thermometer is also allowed to equilibrate under the same atmospheric condition. The front surface of the shroud is then measured again using the same grid-pattern technique and calculations that were used previously, in order to determine the values of the same three temperature metrics specified previously, except this time the results are obtained and reported at the 30° C. atmospheric condition.

The various structural components of the device are disassembled and removed to provide direct access to all surfaces of the electric heating element while it remains functionally attached to the electronic circuit board which powers and controls the electric heating element. Additional care should be taken to ensure safety and prevent electrical shocks during this stage of the measurement process. The insect trapping device with the exposed and functional electric heating element is located in the 23° C. atmospheric condition specified, activated with electrical power, and allowed to heat for at least 30 minutes and until the front surface of the electric heating element reaches a steady state temperature. The surface temperature of the front surface of the electric heating element is measured with the thermocouple in one single location, namely at the approximate center of the surface of the face of the electric heating element. The temperature measurement obtained from the front surface of the electric heating element at the 23° C. atmospheric condition is reported as the set point temperature (Ts) of the device.

### EXAMPLES

The following examples are given solely for the purpose of illustration and are not to be construed as limitations of the invention as many variations are possible without departing from the spirit and the scope of the invention.

### 1. Example #1

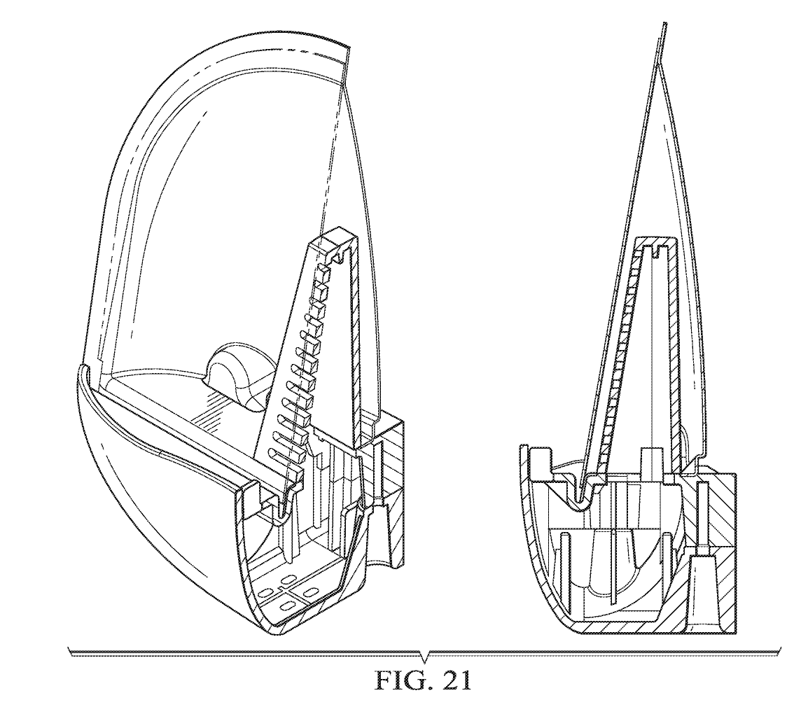

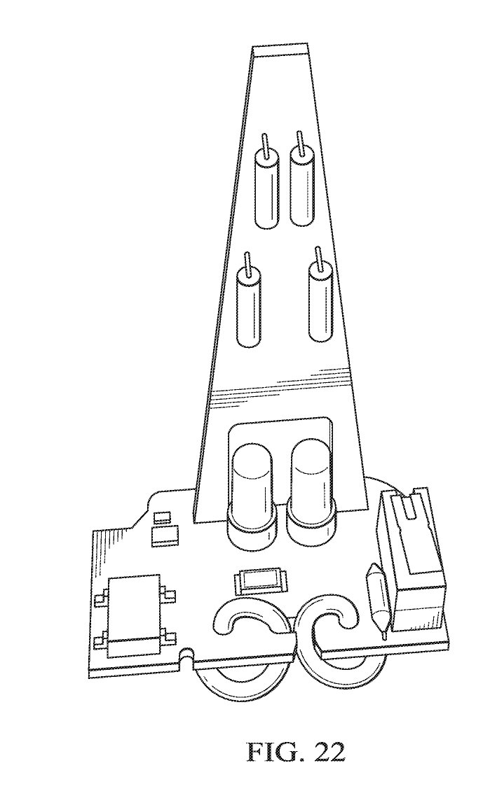

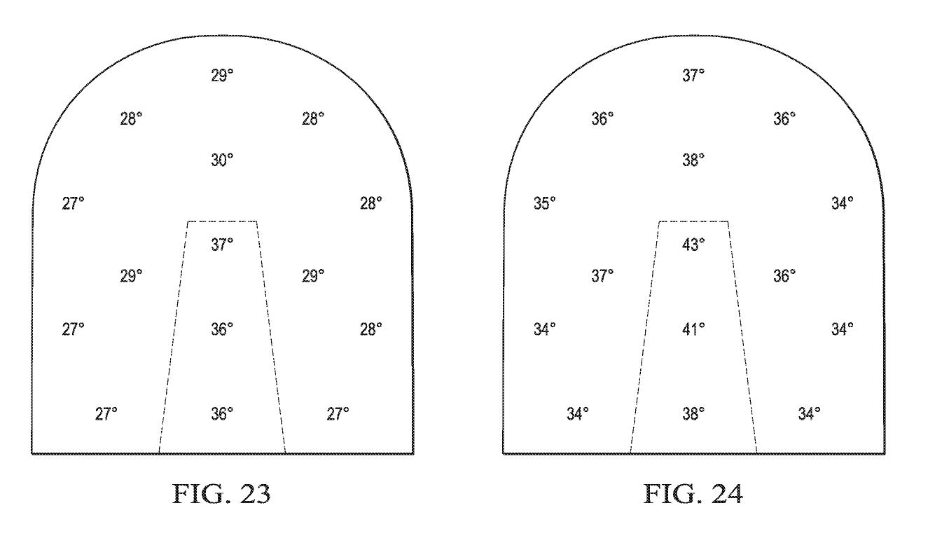

FIGS. 21 and 22 illustrate an example of a base with an upstanding, vented housing containing therein a circuit board with four resistive heating elements and two LEDs. Each of the four resistors was a 3.3 kΩ resistor. This particular design had a front surface area of the upstanding, vented housing (including that of the vents) of about 6.5 cm² compared to an about 58.5 cm² surface area of the rear face of the glue sheet. A cartridge was adapted to engage the base so that the upstanding, vented housing is disposed adjacent the rear face to the glue sheet when the cartridge engaged the base. FIG. 23 illustrates the measured temperatures of the front face of the glue sheet at twelve points at ambient conditions of about 22° C. and about 50% relative humidity. FIG. 24 illustrates the temperatures of the front face of the glue sheet at twelve points at ambient conditions of about 31° C. and about 50% relative humidity. The outline of the shroud is shown in FIGS. 23 and 24 within the interior of the outline of the adhesive portion. All temperature measurements were taken after 1.5 hours of operation and at steady state conditions. The Steady State Average Temperature was 30° C. in FIG. 23 and 37° C. in FIG. 24. The Maximum Steady State Temperature was 37.2° C. in FIG. 23 and 43.3° C. in FIG. 24. The Heat Minimum Steady State Temperature was 26.6° C. in FIG. 23 and 33.8° C. in FIG. 24. The Direct Heat Maximum Steady State Temperature was 37.2° C. in FIG. 23 and 43.3° C. in FIG. 24. Direct Heat Minimum Steady State Temperature was 35.5° C. in FIG. 23 and 38.3° C. in FIG. 24. This Example illustrates a large drop-off in temperature beyond the outline of the shroud despite a higher Steady State Average Temperature than Example #2.

### 2. Example #2

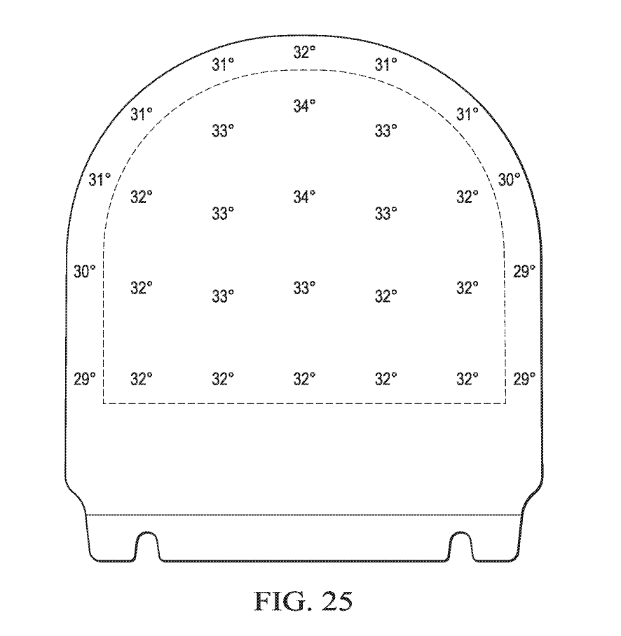

A device similar to that shown in FIGS. 4 to 5 having a base with an upstanding housing containing therein a metal plate heated by a PTC thermistor, model number 15-6-.3 manufactured by ShenZhen Jinke Special Materials Co., Ltd. was tested. This model of PTC thermistor has a target surface temperature of 60° C.+/−5° C. This particular design had a front surface area of the upstanding housing of 35 cm² compared to a 47 cm² surface area of the rear face of the glue sheet. A cartridge similar in design to that shown in FIG. 4 herein was adapted to engage the base so that the upstanding housing was disposed adjacent the rear face to the glue sheet when the cartridge engaged the base. FIG. 25 illustrates the temperatures of the front face of the glue sheet at 29 points at ambient conditions of about 22° C. and 50% relative humidity. The outline of the shroud is shown in FIG. 25 within the interior of the outline of the adhesive portion. All temperature measurements were taken after 1.5 hours of operation and at steady state conditions. The Steady State Average Temperature was 32.5° C. The Maximum Steady State Temperature was 34.4° C. The Heat Minimum Steady State Temperature was 28.9° C. The Direct Heat Maximum Steady State Temperature was 34.4° C. Direct Heat Minimum Steady State Temperature was 31.7° C. This Example illustrates a smaller drop-off in temperature beyond the outline of the shroud despite a lower Steady State Average Temperature than Example #1.

The dimensions and/or values disclosed herein are not to be understood as being strictly limited to the exact numerical dimension and/or values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An insect trapping cartridge for use with a base, comprising:
a proximal end receivable into a base during use, the proximal end comprising a substantially planar, longitudinally extending tab having a first side edge and a second side edge; a distal end opposite the proximal end; an elongate enclosure for receiving an insect; an adhesive surface for trapping the insect;
wherein the insect trapping cartridge has a longitudinal centerline dividing the insect trapping cartridge into lateral sides; and wherein the first side edge and the second side edge of the tab are each laterally offset from the longitudinal centerline of the insect trapping cartridge and positioned on the same
lateral side of the insect trapping cartridge.

2. An insect trapping cartridge according to claim 1, wherein the tab extends proximally away from the elongate enclosure.

3. An insect trapping cartridge according to claim 1, wherein the proximal end further comprises a laterally extending rib.

4. An insect trapping cartridge according to claim 3, wherein the tab extends from the rib.

5. An insect trapping cartridge according to claim 3, wherein the tab is unitary with the rib.

6. An insect trapping cartridge according to claim 3, wherein the rib comprises the tab.

7. An insect trapping cartridge according to claim 1, wherein a front face defines at least part of the enclosure and the proximal end is inwardly recessed from the front face.

8. An insect trapping cartridge according to claim 1, wherein the proximal end has a height from 25 mm to 35 mm.

9. An insect trapping device according to claim 1, wherein the proximal end has a depth from 12 mm to 18 mm.

10. An insect trapping cartridge according to claim 1, wherein the tab has a longitudinal centerline that is laterally offset from the longitudinal centerline of the cartridge by 11 mm to 15 mm.

11. An insect trapping cartridge according to claim 1, wherein the tab has a bottom portion having a longitudinal length distally extending at least 10 mm from a proximal-most point of the bottom portion.

12. An insect trapping cartridge according to claim 1, wherein the tab has an overall width that is less than 25% of the overall width of the proximal end of the cartridge.

13. An insect trapping cartridge according to claim 1, further comprising an opening through which an insect may enter the enclosure.

14. An insect trapping cartridge according to claim 1, wherein the adhesive is disposed at least partially within the enclosure.

15. An insect trapping cartridge according to claim 1, wherein the cartridge further comprises a front surface and a rear surface and the tab is disposed midway between the front surface and the rear surface.

16. An insect trapping cartridge according to claim 1, wherein the cartridge further comprises a bottom opening disposed adjacent to the proximal end.

17. An insect trapping cartridge according to claim 16, wherein the bottom opening extends substantially from one side edge of the cartridge to the opposite side edge of the cartridge.

18. An insect trapping cartridge according to claim 1, wherein the enclosure comprises a front enclosure and a rear enclosure.

19. An insect trapping cartridge according to claim 18, further comprising a divider that divides the enclosure into the front enclosure and the rear enclosure.

20. An insect trapping cartridge according to claim 1, wherein
the tab is configured to pass through an offset slot in a base having a switch.
